(19) United States
(12) Patent Application Publication
(10) Pub. No.: US 2008/0057450 A1
(43) Pub. Date: Mar. 6, 2008

(54) Thermally developable materials containing reducing agent combinations

(75) Inventors: Stacy M. Ulrich, Dresser, WI (US); Doreen C. Lynch, Afton, MN (US); Takuzo Ishida, Woodbury, MN (US); Chaofeng Zou, Maplewood, MN (US); Paul G. Skoug, Stillwater, MN (US); William D. Ramsden, Afton, MN (US)

Correspondence Address: Andrew J. Anderson;Patent Legal Staff, Eastman Kodak Company, 343 State Street, Rochester, NY, 14650-2201, US

(73) Assignee: Eastman Kodak Company

(21) Appl. No.: 11/507,550

(22) Filed: Aug. 21, 2006

(51) Int. Cl. G03C 1/00

(52) U.S. Cl. 430/619

(57) ABSTRACT

Incorporating a combination of phenolic reducing agents provides thermally developable materials with improved silver efficiency and hot-dark print stability without loss in other sensitometric properties. Both photothermographic and thermographic materials are provided, and particularly photothermographic materials having lower silver coverage.

### FIELD OF THE INVENTION

This invention relates to thermally developable materials having a mixture of phenolic reducing agents to provide improved silver efficiency and hot-dark print stability. This invention also relates to methods of imaging and using these materials.

### BACKGROUND OF THE INVENTION

Silver-containing direct thermographic and photothermographic imaging materials (that is, thermally developable imaging materials) that are imaged and/or developed using heat and without liquid processing have been known in the art for many years.

Silver-containing direct thermographic imaging materials are non-photosensitive materials that are used in a recording process wherein images are generated by the direct application of thermal energy and in the absence of a processing solvent. These materials generally comprise a support having disposed thereon (a) a relatively or completely non-photosensitive source of reducible silver ions, (b) a reducing composition (acting as a black-and-white silver developer) for the reducible silver ions, and (c) a suitable binder. Thermographic materials are sometimes called “direct thermal” materials in the art because they are directly imaged by a source of thermal energy without any transfer of the image or image-forming materials to another element (such as in thermal dye transfer).

In a typical thermographic construction, the image-forming thermographic layers comprise non-photosensitive reducible silver salts of long chain fatty acids. A preferred non-photosensitive reducible silver source is a silver salt of a long chain aliphatic carboxylic acid having from 10 to 30 carbon atoms, such as behenic acid or mixtures of acids of similar molecular weight. At elevated temperatures, the silver of the silver carboxylate is reduced by a reducing agent for silver ion (also known as a developer), whereby elemental silver is formed. Preferred reducing agents include methyl gallate, hydroquinone, substituted-hydroquinones, hindered phenols, catechols, pyrogallol, ascorbic acid, and ascorbic acid derivatives.

Some thermographic constructions are imaged by contacting them with the thermal head of a thermographic recording apparatus such as a thermal print-head of a thermal printer or thermal facsimile. In such constructions, an anti-stick layer is coated on top of the imaging layer to prevent sticking of the thermographic construction to the thermal head of the apparatus utilized. The resulting thermographic construction is then heated imagewise to an elevated temperature, typically in the range of from about 60 to about 225° C., resulting in the formation of a black-and-white image of silver.

Silver-containing photothermographic imaging materials (that is, photosensitive thermally developable imaging materials) that are imaged with actinic radiation and then developed using heat and without liquid processing, have also been known in the art for many years. Such materials are used in a recording process wherein an image is formed by imagewise exposure of the photothermographic material to specific electromagnetic radiation (for example, X-radiation, or ultraviolet, visible, or infrared radiation) and developed by the use of thermal energy. These materials, also known as “dry silver” materials, generally comprise a support having coated thereon: (a) a photocatalyst (that is, a photosensitive compound such as silver halide) that upon such exposure provides a latent image in exposed grains that are capable of acting as a catalyst for the subsequent formation of a silver image in a development step, (b) a relatively or completely non-photosensitive source of reducible silver ions, (c) a reducing composition (acting as a developer) for the reducible silver ions, and (d) a binder. The latent image is then developed by application of thermal energy.

In photothermographic materials, exposure of the photosensitive silver halide to light produces small clusters containing silver atoms (Ag⁰)ₙ. The imagewise distribution of these clusters, known in the art as a latent image, is generally not visible by ordinary means. Thus, the photosensitive material must be further developed to produce a visible image. This is accomplished by the reduction of silver ions that are in catalytic proximity to silver halide grains bearing the silver-containing clusters of the latent image. This produces a black-and-white image. The non-photosensitive silver source is catalytically reduced to form the visible black-and-white negative image of silver while much of the silver halide, generally, remains as silver halide and is not reduced.

In photothermographic materials, the reducing agent for the reducible silver ions, often referred to as a “developer”, may be any compound that, in the presence of the latent image, can reduce silver ion to metallic silver and is preferably of relatively low activity until it is heated to a temperature sufficient to cause the reaction. A wide variety of classes of compounds have been disclosed in the literature that function as reducing agents for photothermographic materials. Upon heating, and at elevated temperatures, the reducible silver ions are reduced by the reducing agent. This reaction occurs preferentially in the regions surrounding the latent image and produces a negative image of metallic silver having a color that ranges from yellow to deep black depending upon the presence of toning agents and other components in the photothermographic imaging layer(s).

### Differences Between Photothermography and Photography

The imaging arts have long recognized that the field of photo-thermography is clearly distinct from that of photography. Photothermographic materials differ significantly from conventional silver halide photographic materials that require processing with aqueous processing solutions.

In photothermographic imaging materials, a visible image is created in the absence of a processing solvent by heat as a result of the reaction of a reducing agent incorporated within the material. Heating at 50° C. or more is essential for this dry development. In contrast, conventional photographic imaging materials require processing in aqueous processing baths at more moderate temperatures (from 30° C. to 50° C.) to provide a visible image.

In photothermographic materials, only a small amount of silver halide is used to capture light and a non-photosensitive source of reducible silver ions (for example, a silver carboxylate or a silver benzotriazole) is used to generate the visible image using thermal development. Thus, the imaged photosensitive silver halide serves as a catalyst for the physical development process involving the non-photosensitive source of reducible silver ions and the incorporated reducing agent. In contrast, conventional wet-processed, black-and-white photographic materials use only one form of silver (that is, silver halide) that, upon chemical development, is itself at least partially converted into the silver image, or that upon physical development requires addition of an external silver source (or other reducible metal ions that form black images upon reduction to the corresponding metal). Thus, photothermographic materials require an amount of silver halide per unit area that is only a fraction of that used in conventional wet-processed photographic materials.

In photothermographic materials, all of the “chemistry” for imaging is incorporated within the material itself. For example, such materials include a reducing agent (that is, a developer for the reducible silver ions) while conventional photographic materials usually do not. The incorporation of the reducing agent into photothermographic materials can lead to increased formation of various types of “fog” or other undesirable sensitometric side effects.

Therefore, much effort has gone into the preparation and manufacture of photo-thermographic materials to minimize these problems.

Moreover, in photothermographic materials, the unexposed silver halide generally remains intact after development and the material must be stabilized against further imaging and development. In contrast, silver halide is removed from conventional photographic materials after solution development to prevent further imaging (that is in the aqueous fixing step).

Because photothermographic materials require dry thermal processing, they present distinctly different problems and require different materials in manufacture and use, compared to conventional, wet-processed silver halide photographic materials. Additives that have one effect in conventional silver halide photographic materials may behave quite differently when incorporated in photothermographic materials where the underlying chemistry is significantly more complex. The incorporation of such additives as, for example, stabilizers, antifoggants, speed enhancers, supersensitizers, and spectral and chemical sensitizers in conventional photographic materials is not predictive of whether such additives will prove beneficial or detrimental in photothermographic materials. For example, it is not uncommon for a photographic antifoggant useful in conventional photographic materials to cause various types of fog when incorporated into photothermographic materials, or for supersensitizers that are effective in photographic materials to be inactive in photothermographic materials.

These and other distinctions between photothermographic and photographic materials are described in Unconventional Imaging Processe, E. Brinckman et al. (Eds.), The Focal Press, London and New York, 1978, pp. 74-75, in D. H. Klosterboer, Imaging Processes and Materials, (Neblette's Eighth Edition), J. Sturge, V. Walworth, and A. Shepp, Eds., Van Nostrand-Reinhold, New York, 1989, Chapter 9, pp. 279-291, in C. Zou et al., J. Imaging Sci. Technol. 1996, 40, pp. 94-103, and in M. R. V. Sahyun, J. Imaging Sci. Technol. 1998, 42, 23.

### Problem to be Solved

One problem encountered in the use of thermally developable materials is inadequate covering power by the developed silver image. This can be caused by incomplete development of the non-photosensitive silver salt, by the morphology of the developed silver, or by a combination of these two factors. Increased covering power results in higher image density for the same amount of thermally developable silver salt and allows lower silver coating weights to be utilized. Because silver salts are expensive, increased covering power can lower manufacturing costs. A convenient measure of covering power is “silver efficiency”, the maximum density (Dₘₐₓ) of an imaged and processed thermally developable material divided by the silver coating weight.

U.S. Pat. Nos. 6,413,712 (Yoshioka et al.) and U.S. Pat. No. 6,645,714 (Oya et al.) describe various binary mixtures of bisphenols with monophenols or trisphenols with monophenols as reducing agents (developers) in photothermographic materials.

Despite the considerable research and knowledge in the art relating to various reducing agents in thermally developable materials, there remains a need for additional effective reducing agent combinations that provide more efficient use of silver and allow a reduction in the amount of silver needed to reach a given density.

### SUMMARY OF THE INVENTION

To address this need, this invention provides a thermally developable material comprising a support having on at least one side thereof, one or more thermally developable imaging layers comprising in reactive association:

a. a non-photosensitive source of reducible silver ions,

b. a combination of reducing agents for the reducible silver ions, and

c. a polymeric binder,

wherein the combination of reducing agents comprises at least one trisphenol represented by the following Structure (I), and

(a) at least one monophenol represented by the following Structure (II) or at least one bisphenol represented by the following Structure (III), or

(b) at least one monophenol represented by the following Structure (II) and at least one bisphenol represented by the following Structure (III):

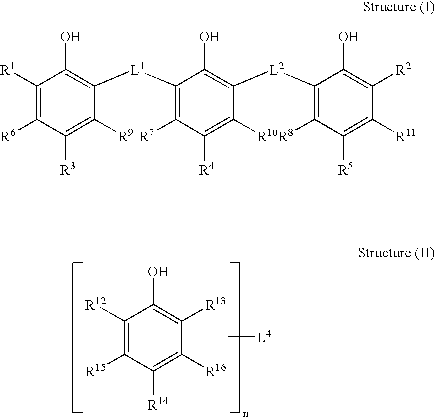

wherein L¹, L², and L³ are independently sulfur or a mono-substituted or unsubstituted methylene group,

R¹ and R² are independently primary or secondary substituted or unsubstituted alkyl groups having I to 12 carbon atoms,

R³, R⁴, R⁵, R¹⁹, and R²⁰ are independently substituted or unsubstituted alkyl groups having 1 to 12 carbon atoms, substituted or unsubstituted alkoxy groups having 1 to 12 carbon atoms, or halo groups,

R⁶, R⁷, R⁸, R⁹, R¹⁰, R¹¹, R²¹, R²², R²³ and R²⁴ are independently hydrogen or any substituent that is substitutable on a benzene ring,

R¹² and R¹³ are independently substituted or unsubstituted alkyl exclusive of 2-hydroxyphenylmethyl groups, substituted or unsubstituted alkoxy, or halo groups, or hydrogen, such that both R¹² and R¹³ are not both simultaneously hydrogen,

R¹⁴, R¹⁵, and R¹⁶ are independently hydrogen, or any substituent that is substitutable on a benzene ring,

R¹⁷ and R¹⁸ are independently substituted or unsubstituted alkyl groups, and

n is an integer of 1 or greater, provided that when n is 2 or greater, L⁴ is a single bond or a linking group that is attached to any of R¹², R¹³, R¹⁴, R¹⁵ or R¹⁶.

This invention also provides a photothermographic material comprising a support having on at least one side thereof, one or more thermally developable imaging layers comprising in reactive association:

a. a photosensitive silver halide,

b. a non-photosensitive source of reducible silver ions,

c. a combination of reducing agents for the reducible silver ions, and

d. a polymeric binder,

wherein said combination of reducing agents comprises at least one trisphenol represented by the Structure (I) identified above, and

(a) at least one monophenol represented by Structure (II) identified above or at least one bisphenol represented by Structure (III) identified above, or

(b) at least one monophenol represented by Structure (II) identified above and at least one bisphenol represented by Structure (III) identified above.

In preferred embodiments, the invention includes a black-and-white, organic solvent based photothermographic material comprising a support and having on at least one side thereof a photothermographic layer and comprising, in reactive association:

a. a photosensitive silver halide,

b. a non-photosensitive source of reducible silver ions, comprising at least silver behenate,

c. a combination of reducing agents for the reducible silver ions, and

d. a polyvinyl butyral or polyvinyl acetal binder, and

wherein the total amount of silver is present in an amount of at least 1 g/m² and less than or equal to 2.5 g/m²,

the combination of reducing agents includes the combination of either or both of Compounds I-2 and I-3 with either or both of Compounds II-8 and II-17,

the combination of either or both of Compounds I-2 and I-3 with either or both of Compounds III- 1 and III-4, or

the combination of either or both of Compounds I-2 and I-3 with either or both of Compounds II-8 and II-17 and either or both of Compounds III-1 and III-4,

a co-developer compound that is optionally present in an amount of from about 0.0005 to about 0.15 g/m², and

a high contrast enhancing agent that is optionally present in an amount of from about 0.001 to about 0.5 g/m².

This invention further provides a method of forming a visible image comprising:

(A) imagewise exposing a thermally developable material of this invention that is a photothermographic material to electromagnetic radiation to form a latent image,

(B) simultaneously or sequentially, heating the exposed photothermo-graphic material to develop the latent image into a visible image.

In alternative methods of this invention, a method of forming a visible image comprises:

(A′) thermal imaging of the thermally developable material of this invention that is a thermographic material.

We have found that by incorporating specific combinations of a mixture of trisphenol with monophenol and/or bisphenol reducing agents in the thermally developable materials, we have improved Silver Efficiency with little change in other sensitometric properties. In fact, initial Dₘᵢₙ and print stability in the dark during storage under hot conditions (known as “hot-dark print stability”) are improved. Additionally, improvements in Image Tone may also be obtained. These advantages are particularly evident when the coating level of silver is reduced from those normally used in photothermographic materials.

### DETAILED DESCRIPTION OF THE INVENTION

The thermally developable materials described herein are both thermographic and photothermographic materials. While the following discussion will often be directed primarily to the preferred photothermographic embodiments, it would be readily understood by one skilled in the art that thermo-graphic materials can be similarly constructed and used to provide black-and-white or color images using appropriate imaging chemistry and particularly non-photosensitive organic silver salts, reducing agents, toners, binders, and other components known to a skilled artisan. In both thermographic and photothermo-graphic materials, the reducing agent combinations described herein are in reactive association with the non-photosensitive silver salt.

The thermally developable materials described herein can be used in black-and-white or color thermography or photothermography and in electronically generated black-and-white or color hardcopy recording. They can be used in microfilm applications, in radiographic imaging (for example digital medical imaging), X-ray radiography, and in industrial radiography. Furthermore, the absorbance of these materials between 350 and 450 nm is desirably low (less than 0.5), to permit their use in the graphic arts area (for example, image-setting and phototype-setting), in the manufacture of printing plates, in contact printing, in duplicating (“duping”), and in proofing.

The thermally developable materials are particularly useful for imaging of human or animal subjects in response to, X-radiation, ultraviolet, visible, or infrared radiation for use in a medical diagnosis. Such applications include, but are not limited to, thoracic imaging, mammography, dental imaging, orthopedic imaging, general medical radiography, therapeutic radiography, veterinary radiography, and autoradiography. When used with X-radiation, the photothermographic materials may be used in combination with one or more phosphor intensifying screens, with phosphors incorporated within the photothermographic emulsion, or with combinations thereof. Such materials are particularly useful for dental radiography when they are directly imaged by X-radiation. The materials are also useful for non-medical uses of X-radiation such as X-ray lithography and industrial radiography.

The photothermographic materials can be made sensitive to radiation of any suitable wavelength. Thus, in some embodiments, the materials are sensitive at ultraviolet, visible, infrared, or near infrared wavelengths, of the electromagnetic spectrum. In preferred embodiments, the materials are sensitive to radiation greater than 600 nm (and preferably sensitive to infrared radiation from about 700 up to about 950 nm). Increased sensitivity to a particular region of the spectrum is imparted through the use of various spectral sensitizing dyes.

In the photothermographic materials, the components needed for imaging can be in one or more photothermographic imaging layers on one side (“frontside”) of the support. The layer(s) that contain the photosensitive photo-catalyst (such as a photosensitive silver halide) or non-photosensitive source of reducible silver ions, or both, are referred to herein as photothermographic emulsion layer(s). The photocatalyst and the non-photosensitive source of reducible silver ions are in catalytic proximity and preferably are in the same emulsion layer.

Similarly, in the thermographic materials, the components needed for imaging can be in one or more layers. The layer(s) that contain the non-photo-sensitive source of reducible silver ions are referred to herein as thermographic emulsion layer(s).

Where the photothermographic materials contain imaging layers on one side of the support only, various non-imaging layers are usually disposed on the “backside” (non-emulsion or non-imaging side) of the materials, including conductive/antistatic layers, antihalation layers, protective layers, and transport enabling layers.

Various non-imaging layers can also be disposed on the “frontside” or imaging or emulsion side of the support, including protective frontside overcoat layers, primer layers, interlayers, opacifying layers, conductive/antistatic layers, antihalation layers, acutance layers, auxiliary layers, and other layers readily apparent to one skilled in the art.

For some embodiments, it may be useful that the photothermo-graphic materials be “double-sided” or “duplitized” and have the same or different photothermographic coatings (or imaging layers) on both sides of the support. In such constructions each side can also include one or more protective overcoat layers, primer layers, interlayers, acutance layers, conductive/antistatic layers auxiliary layers, anti-crossover layers, and other layers readily apparent to one skilled in the art, as well as the required conductive layer(s).

When the thermally developable materials are heat-developed as described below in a substantially water-free condition after, or simultaneously with, imagewise exposure, a silver image (preferably a black-and-white silver image) is obtained.

### Definitions

As used herein:

In the descriptions of the photothermographic materials, “a” or “an” component refers to “at least one” of that component (for example, the combination of reducing agent compounds described herein).

As used herein, “black-and-white” preferably refers to an image formed by silver metal.

Unless otherwise indicated, when the terms “thermally developable materials”, “photothermographic materials”, and “thermographic materials” are used herein, the terms refer to materials of the present invention.

Heating in a substantially water-free condition as used herein, means heating at a temperature of from about 50° C. to about 250° C. with little more than ambient water vapor present. The term “substantially water-free condition” means that the reaction system is approximately in equilibrium with water in the air and water or any other solvent for inducing or promoting the reaction is not particularly or positively supplied from the exterior to the material. Such a condition is described in T. H. James, The Theory of the Photographic Process, Fourth Edition, Eastman Kodak Company, Rochester, N.Y., 1977, p. 374.

“Photothermographic material(s)” means a dry processable integral element comprising a support and at least one photothermographic emulsion layer or a photothermographic set of emulsion layers (wherein the photosensitive silver halide and the source of reducible silver ions are in one layer and the other necessary components or additives are distributed, as desired, in the same layer or in an adjacent coated layer). In the case of black-and-white thermally developable materials, a black-and-white silver image is produced. These materials also include multilayer constructions in which one or more imaging components are in different layers, but are in “reactive association”. For example, one layer can include the non-photosensitive source of reducible silver ions and another layer can include the reducing composition, but the two reactive components are in reactive association with each other. By “integral”, we mean that all imaging chemistry required for imaging is in the material without diffusion of imaging chemistry or reaction products (such as a dye) from or to another element (such as a receiver element).

“Thermographic materials” are similarly defined except that no photosensitive silver halide catalyst is purposely added or created.

When used in photothermography, the term, “imagewise exposing” or “imagewise exposure” means that the material is imaged as a dry processable material using any exposure means that provides a latent image using electro-magnetic radiation. This includes, for example, by analog exposure where an image is formed by projection onto the photosensitive material as well as by digital exposure where the image is formed one pixel at a time such as by modulation of scanning laser radiation.

When used in thermography, the term, “imagewise exposing” or “imagewise exposure” means that the material is imaged as a dry processable material using any means that provides an image using heat. This includes, for example, by analog exposure where an image is formed by differential contact heating through a mask using a thermal blanket or infrared heat source, as well as by digital exposure where the image is formed one pixel at a time such as by modulation of thermal print-heads or by thermal heating using scanning laser radiation.

The term “emulsion layer”, “imaging layer”, “thermographic emulsion layer”, or “photothermographic emulsion layer” means a layer of a thermographic or photothermographic material that contains the photosensitive silver halide (when used) and/or non-photosensitive source of reducible silver ions, or a reducing composition. Such layers can also contain additional components or desirable additives. These layers are on what is referred to as the “frontside” of the support.

“Photocatalyst” means a photosensitive compound such as silver halide that, upon exposure to radiation, provides a compound that is capable of acting as a catalyst for the subsequent development of the image-forming material.

“Catalytic proximity” or “reactive association” means that the reactive components are in the same layer or in adjacent layers so that they readily come into contact with each other during imaging and thermal development.

“Simultaneous coating” or “wet-on-wet” coating means that when multiple layers are coated, subsequent layers are coated onto the initially coated layer before the initially coated layer is dry. Simultaneous coating can be used to apply layers on the frontside, backside, or both sides of the support.

“Transparent” means capable of transmitting visible light or imaging radiation without appreciable scattering or absorption.

The phrases “silver salt” and “organic silver salt” refer to an organic molecule having a bond to a silver atom. Although the compounds so formed are technically silver coordination complexes or silver compounds they are also often referred to as silver salts.

The phrase “aryl group” refers to an organic group derived from an aromatic hydrocarbon by removal of one atom, such as a phenyl group formed by removal of one hydrogen atom from benzene.

“Silver Efficiency” is defined as Dₘₐₓ divided by the total silver coating weight in units of g/m².

The term “buried layer” means that there is at least one other layer disposed over the layer (such as a “buried” backside conductive layer).

The terms “coating weight”, “coat weight”, and “coverage” are synonymous, and are usually expressed in weight or moles per unit area such as g/m² or mol/m².

“Ultraviolet region of the spectrum” refers to that region of the spectrum less than or equal to 400 nm (preferably from about 100 nm to about 400 nm) although parts of these ranges may be visible to the naked human eye.

“Visible region of the spectrum” refers to that region of the spectrum of from about 400 nm to about 700 nm.

“Short wavelength visible region of the spectrum” refers to that region of the spectrum of from about 400 nm to about 450 nm.

“Red region of the spectrum” refers to that region of the spectrum of from about 600 nm to about 700 nm.

“Infrared region of the spectrum” refers to that region of the spectrum of from about 700 nm to about 1400 nm.

“Non-photosensitive” means not intentionally light sensitive.

The sensitometric terms “photospeed”, “speed”, or “photographic speed” (also known as sensitivity), absorbance, and contrast have conventional definitions known in the imaging arts. The sensitometric term absorbance is another term for optical density (OD).

The term “hot-dark print stability” refers to the susceptibility of imaged and processed (photo)thermographic materials to undergo changes in such properties as Dₘᵢₙ, Dₘₐₓ, tint, and tone during storage under hot conditions in the absence of light.

Image Tone refers to a measure of the extent of yellowness of the silver image. It is the difference in the optical density measured using a blue filter, from that of the optical density measured using a visible filter, at a visible density of 2.0. Larger Image Tone values indicate a bluer image. For use in medical imaging applications, a bluer image is generally preferred.

Speed-2 is Log1/E+4 corresponding to the density value of 1.0 above Dₘᵢₙ where E is the exposure in ergs/cm².

Average Contrast-1 (“AC-1”) is the absolute value of the slope of the line joining the density points at 0.60 and 2.00 above Dₘᵢₙ.

In photothermographic materials, the term Dₘᵢₙ (lower case) is considered herein as image density achieved when the photothermographic material is thermally developed without prior exposure to radiation. The term Dₘₐₓ (lower case) is the maximum image density achieved in the imaged area of a particular sample after imaging and development.

The term D_{MIN} (upper case) is the density of the nonimaged, undeveloped material. The term D_{MAX} (upper case) is the maximum image density achievable when the photothermographic material is exposed and then thermally developed. D_{MAX} is also known as “Saturation Density”.

As is well understood in this art, for the chemical compounds herein described, substitution is not only tolerated, but is often advisable and various substituents are anticipated on the compounds used in the present invention unless otherwise stated. Thus, when a compound is referred to as “having the structure” of a given formula or being a “derivative” of a compound, any substitution that does not alter the bond structure of the formula or the shown atoms within that structure is included within the formula, unless such substitution is specifically excluded by language.

As a means of simplifying the discussion and recitation of certain substituent groups, the term “group” refers to chemical species that may be substituted as well as those that are not so substituted. Thus, the term “alkyl group” is intended to include not only pure hydrocarbon alkyl chains, such as methyl, ethyl, n-propyl, t-butyl, cyclohexyl, iso-octyl, and octadecyl, but also alkyl chains bearing substituents known in the art, such as hydroxyl, alkoxy, phenyl, halogen atoms (F, Cl, Br, and I), cyano, nitro, amino, and carboxy. For example, alkyl group includes ether and thioether groups (for example CH₃—CH₂—CH₂—O—CH₂— and CH₃—CH₂—CH₂—S—CH₂—), haloalkyl, nitroalkyl, alkylcarboxy, carboxyalkyl, carboxamido, hydroxyalkyl, sulfoalkyl, and other groups readily apparent to one skilled in the art. Substituents that adversely react with other active ingredients, such as very strongly electrophilic or oxidizing substituents, would, of course, be excluded by the skilled artisan as not being inert or harmless.

Research Disclosure (http://www.researchdisclosure.com) is a publication of Kenneth Mason Publications Ltd., The Book Barn, Westboume, Hampshire PO10 8RS, UK. It is also available from Emsworth Design Inc., 200 Park Avenue South, Room 1101, New York, N.Y. 10003.

Other aspects, advantages, and benefits of the present invention are apparent from the detailed description, examples, and claims provided in this application.

### The Photocatalyst

As noted above, photothermographic materials include one or more photocatalysts in the photothermographic emulsion layer(s). Useful photo-catalysts are typically photosensitive silver halides such as silver bromide, silver iodide, silver chloride, silver bromoiodide, silver chlorobromoiodide, silver chlorobromide, and others readily apparent to one skilled in the art. Mixtures of silver halides can also be used in any suitable proportion. Silver bromide and silver iodide are preferred. More preferred is silver bromoiodide in which any suitable amount of iodide is present up to almost 100% silver iodide and more likely up to about 40 mol % silver iodide. Even more preferably, the silver bromoiodide comprises at least 70 mole % (preferably at least 85 mole % and more preferably at least 90 mole %) bromide (based on total silver halide). The remainder of the halide is iodide, chloride, or chloride and iodide. Preferably the additional halide is iodide. Silver bromide and silver bromoiodide are most preferred, with the latter silver halide generally having up to 10 mole % silver iodide.

In some embodiments of aqueous-based photothermographic materials, higher amounts of iodide may be present in homogeneous photo-sensitive silver halide grains, and particularly from about 20 mol % up to the saturation limit of iodide as described, for example, U.S. Patent Application Publication 2004/0053173 (Maskasky et al.).

The silver halide grains may have any crystalline habit or morphology including, but not limited to, cubic, octahedral, tetrahedral, orthorhombic, rhombic, dodecahedral, other polyhedral, tabular, laminar, twinned, or platelet morphologies and may have epitaxial growth of crystals thereon. If desired, a mixture of grains with different morphologies can be employed. Silver halide grains having cubic and tabular morphology (or both) are preferred.

The silver halide grains may have a uniform ratio of halide throughout. They may also have a graded halide content, with a continuously varying ratio of, for example, silver bromide and silver iodide or they may be of the core-shell type, having a discrete core of one or more silver halides, and a discrete shell of one or more different silver halides. Core-shell silver halide grains useful in photothermographic materials and methods of preparing these materials are described in U.S. Pat. No. 5,382,504 (Shor et al.). Iridium and/or copper doped core-shell and non-core-shell grains are described in U.S. Pat. No. 5,434,043 (Zou et al.) and U.S. Pat. No. 5,939,249 (Zou). Bismuth(III)-doped high silver iodide emulsions for aqueous-based photothermographic materials are described in U.S. Pat. No. 6,942,960 (Maskasky et al.).

In some instances, it may be helpful to prepare the photosensitive silver halide grains in the presence of a hydroxytetraazaindene (such as 4-hydroxy-6-methyl-1,3,3a,7-tetraazaindene) or an N-heterocyclic compound comprising at least one mercapto group (such as 1-phenyl-5-mercaptotetrazole) as described in U.S. Pat. No. 6,413,710 (Shor et al.).

The photosensitive silver halide can be added to (or formed within) the emulsion layer(s) in any fashion as long as it is placed in catalytic proximity to the non-photosensitive source of reducible silver ions.

It is preferred that the silver halides be preformed and prepared by an ex-situ process. With this technique, one has the possibility of more precisely controlling the grain size, grain size distribution, dopant levels, and composition of the silver halide, so that one can impart more specific properties to both the silver halide grains and the resulting photothermographic material.

In some constructions, it is preferable to form the non-photo-sensitive source of reducible silver ions in the presence of ex-situ-prepared silver halide. In this process, the source of reducible silver ions, such as a long chain fatty acid silver carboxylate (commonly referred to as a silver “soap” or homogenate), is formed in the presence of the preformed silver halide grains. Co-precipitation of the source of reducible silver ions in the presence of silver halide provides a more intimate mixture of the two materials to provide a material often referred to as a “preformed soap” [see U.S. Pat. No. 3,839,049 (Simbns)].

In some constructions, it is preferred that preformed silver halide grains be added to and “physically mixed” with the non-photosensitive source of reducible silver ions.

Preformed silver halide emulsions can be prepared by aqueous or organic processes and can be unwashed or washed to remove soluble salts. Soluble salts can be removed by any desired procedure for example as described in U.S. Pat. No. 2,489,341 (Waller et al.), U.S. Pat. No. 2,565,418 (Yackel), U.S. Pat. No. 2,614,928 (Yutzy et al.), U.S. Pat. No. 2,618,556 (Hewitson et al.), and U.S. Pat. No. 3,241,969 (Hart et al.).

It is also effective to use an in-situ process in which a halide- or a halogen-containing compound is added to an organic silver salt to partially convert the silver of the organic silver salt to silver halide. Inorganic halides (such as zinc bromide, zinc iodide, calcium bromide, lithium bromide, lithium iodide, or mixtures thereof) or an organic halogen-containing compound (such as N-bromo-succinimide or pyridinium hydrobromide perbromide) can be used. The details of such in-situ generation of silver halide are well known and described in U.S. Pat. No. 3,457,075 (Morgan et al.).

It is particularly effective to use a mixture of both preformed and in-situ generated silver halide. The preformed silver halide is preferably present in a preformed soap.

Additional methods of preparing silver halides and organic silver salts and blending them are described in Research Disclosure, June 1978, item 17029, U.S. Pat. No. 3,700,458 (Lindholm) and U.S. Pat. No. 4,076,539 (Ikenoue et al.), and Japan Kokai 49-013224 (Fuji), 50-017216 (Fuji), and 51-042529 (Fuji).

The silver halide grains used in the imaging formulations can vary in average diameter of up to several micrometers (aim) depending on the desired use. Preferred silver halide grains for use in preformed emulsions containing silver carboxylates are cubic grains having a number average particle size of from about 0.01 to about 1.0 μm, more preferred are those having a number average particle size of from about 0.03 to about 0.1 μm. It is even more preferred that the grains have a number average particle size of 0.06 μm or less, and most preferred that they have a number average particle size of from about 0.03 to about 0.06 μm. Mixtures of grains of various average particle size can also be used. Preferred silver halide grains for high-speed photothermographic constructions use are tabular grains having an average thickness of at least 0.02 μm and up to and including 0.10 μm, an equivalent circular diameter of at least 0.5 μm and up to and including 8 μm and an aspect ratio of at least 5:1. More preferred are those having an average thickness of at least 0.03 μm and up to and including 0.08 μm, an equivalent circular diameter of at least 0.75 μm and up to and including 6 μm and an aspect ratio of at least 10:1.

The average size of the photosensitive silver halide grains is expressed by the average diameter if the grains are spherical, and by the average of the diameters of equivalent circles for the projected images if the grains are cubic or in other non-spherical shapes. Representative grain sizing methods are described in Particle Size Analysis, ASTM Symposium on Light Microscopy, R. P. Loveland, 1955, pp. 94-122, and in C. E. K. Mees and T. H. James, The Theory of the Photographic Process, Third Edition, Macmillan, New York, 1966, Chapter 2. Particle size measurements may be expressed in terms of the projected areas of grains or approximations of their diameters. These will provide reasonably accurate results if the grains of interest are substantially uniform in shape.

The one or more light-sensitive silver halides are preferably present in an amount of from about 0.005 to about 0.5 mole, more preferably from about 0.01 to about 0.25 mole, and most preferably from about 0.03 to about 0.15 mole, per mole of non-photosensitive source of reducible silver ions.

### Chemical Sensitization

The photosensitive silver halides can be chemically sensitized using any useful compound that contains sulfur, tellurium, or selenium, or may comprise a compound containing gold, platinum, palladium, ruthenium, rhodium, iridium, or combinations thereof, a reducing agent such as a tin halide or a combination of any of these. The details of these materials are provided for example, in T. H. James, The Theory of the Photographic Process, Fourth Edition, Eastman Kodak Company, Rochester, N.Y., 1977, Chapter 5, pp. 149-169. Suitable conventional chemical sensitization procedures are also described in U.S. Pat. No. 1,623,499 (Sheppard et al.), U.S. Pat. No. 2,399,083 (Waller et al.), U.S. Pat. No. 3,297,446 (Dunn), U.S. Pat. No. 3,297,447 (McVeigh), U.S. Pat. No. 5,049,485 (Deaton), U.S. Pat. No. 5,252,455 (Deaton), 5,391,727 (Deaton), U.S. Pat. No. 5,759,761 (Lushington et al.), and U.S. Pat. No. 5,912,111 (Lok et al.), and EP 0 915 371A1 (Lok et al.).

Mercaptotetrazoles and tetraazindenes as described in U.S. Pat. No. 5,691,127 (Daubendiek et al.) can also be used as suitable addenda for tabular silver halide grains.

Certain substituted and unsubstituted thiourea compounds can be used as chemical sensitizers including those described in U.S. Pat. No. 6,368,779 (Lynch et al.).

Still other additional chemical sensitizers include certain tellurium-containing compounds that are described in U.S. Pat. No. 6,699,647 (Lynch et al.), and certain selenium-containing compounds that are described in U.S. Pat. No. 6,620,577 (Lynch et al.).

Combinations of gold(III)-containing compounds and either sulfur-, tellurium-, or selenium-containing compounds are also useful as chemical sensitizers as described in U.S. Pat. No. 6,423,481 (Simpson et al.).

In addition, sulfur-containing compounds can be decomposed on silver halide grains in an oxidizing environment according to the teaching in U.S. Pat. No. 5,891,615 (Winslow et al.). Examples of sulfur-containing compounds that can be used in this fashion include sulfur-containing spectral sensitizing dyes. Other useful sulfur-containing chemical sensitizing compounds that can be decomposed in an oxidizing environment are the diphenylphosphine sulfide compounds described in U.S. Pat. No. 7,026,105 (Simpson et al.) and U.S. Pat. No. 7,063,941 (Burleva et al.), and in U.S. Patent Application Publication 2005/0123871 (Burleva et al.).

The chemical sensitizers can be present in conventional amounts that generally depend upon the average size of the silver halide grains. Generally, the total amount is at least 10⁻¹ mole per mole of total silver, and preferably from about 10⁻⁸ to about 10⁻² mole per mole of total silver for silver halide grains having an average size of from about 0.01 to about 1 μm.

### Spectral Sensitization

The photosensitive silver halides may be spectrally sensitized with one or more spectral sensitizing dyes that are known to enhance silver halide sensitivity to ultraviolet, visible, and/or infrared radiation (that is, sensitivity within the range of from about 300 to about 1400 nm). It is preferred that the photosensitive silver halide be sensitized to infrared radiation (that is from about 700 to about 950 nm). Non-limiting examples of spectral sensitizing dyes that can be employed include cyanine dyes, merocyanine dyes, complex cyanine dyes, complex merocyanine dyes, holopolar cyanine dyes, hemicyanine dyes, styryl dyes, and hemioxanol dyes. They may be added at any stage in the preparation of the photothermographic emulsion, but are generally added after chemical sensitization is achieved.

Suitable spectral sensitizing dyes such as those described in U.S. Pat. No. 3,719,495 (Lea), U.S. Pat. No. 4,396,712 (Kinoshita et al.), U.S. Pat. No. 4,439,520 (Kofron et al.), U.S. Pat. No. 4,690,883 (Kubodera et al.), U.S. Pat. No. 4,840,882 (Iwagaki et al.), U.S. Pat. No. 5,064,753 (Kohno et al.), U.S. Pat. No. 5,281,515 (Delprato et al.), U.S. Pat. No. 5,393,654 (Burrows et al.), U.S. Pat. No. 5,441,866 (Miller et al.), U.S. Pat. No. 5,508,162 (Dankosh), U.S. Pat. No. 5,510,236 (Dankosh), and 5,541,054 (Miller et al.), Japan Kokai 2000-063690 (Tanaka et al.), 2000-112054 (Fukusaka et al.), 2000-273329 (Tanaka et al.), 2001-005145 (Arai), 2001-064527 (Oshiyama et al.), and 2001-154305 (Kita et al.) can be used. Useful spectral sensitizing dyes are also described in Research Disclosure, December 1989, item 308119, Section IV and Research Disclosure, 1994, item 36544, section V.

Teachings relating to specific combinations of spectral sensitizing dyes also include U.S. Pat. No. 4,581,329 (Sugimoto et al.), U.S. Pat. No. 4,582,786 (Ikeda et al.), U.S. Pat. No. 4,609,621 (Sugimoto et al.), U.S. Pat. No. 4,675,279 (Shuto et al.), 4,678,741 (Yamada et al.), U.S. Pat. No. 4,720,451 (Shuto et al.), U.S. Pat. No. 4,818,675 (Miyasaka et al.), 4,945,036 (Arai et al.), and U.S. Pat. No.4,952,491 (Nishikawa et al.).

Also useful are spectral sensitizing dyes that decolorize by the action of light or heat as described in U.S. Pat. No. 4,524,128 (Edwards et al.) and Japan Kokai 2001-109101 (Adachi), 2001-154305 (Kita et al.), and 2001-183770 (Hanyu et al.).

Dyes and other compounds may be selected for the purpose of supersensitization to attain much higher sensitivity than the sum of sensitivities that can be achieved by using a sensitizer alone. Examples of such supersensitizers include the metal chelating compounds disclosed in U.S. Pat. No. 4,873,184 (Simpson), the large cyclic compounds featuring a heteroatom disclosed in U.S. Pat. No. 6,475,710 (Kudo et al.), the stilbene compounds disclosed in EP 0 821 271 (Uytterhoeven et al.).

An appropriate amount of spectral sensitizing dye added is generally about 10⁻¹⁰ to 10⁻¹ mole, and preferably, about 10-7 to 10-2 mole per mole of silver halide.

### Non-Photosensitive Source of Reducible Silver Ions

The non-photosensitive source of reducible silver ions in the thermally developable materials is a silver-organic compound that contains reducible silver(I) ions. Such compounds are generally silver salts of silver organic coordinating ligands that are comparatively stable to light and form a silver image when heated to 50° C. or higher in the presence of an exposed photocatalyst (such as silver halide, when used in a photothermographic material) and a reducing agent composition.

The primary organic silver salt is often a silver salt of an aliphatic carboxylic acid (described below). Mixtures of silver salts of aliphatic carboxylic acids are particularly useful where the mixture includes at least silver behenate.

Useful silver carboxylates include silver salts of long-chain aliphatic carboxylic acids. The aliphatic carboxylic acids generally have aliphatic chains that contain 10 to 30, and preferably 15 to 28, carbon atoms. Examples of such preferred silver salts include silver behenate, silver arachidate, silver stearate, silver oleate, silver laurate, silver caprate, silver myristate, silver palmitate, silver maleate, silver fumarate, silver tartarate, silver furoate, silver linoleate, silver butyrate, silver camphorate, and mixtures thereof. Most preferably, at least silver behenate is used alone or in mixtures with other silver carboxylates.

Silver salts other than the silver carboxylates described above can be used also. Such silver salts include silver salts of aliphatic carboxylic acids containing a thioether group as described in U.S. Pat. No. 3,330,663 (Weyde et al.), soluble silver carboxylates comprising hydrocarbon chains incorporating ether or thioether linkages or sterically hindered substitution in the α-(on a hydrocarbon group) or ortho-(on an phenyl group) position as described in U.S. Pat. No. 5,491,059 (Whitcomb), silver salts of dicarboxylic acids, silver salts of sulfonates as described in U.S. Pat. No. 4,504,575 (Lee), silver salts of sulfosuccinates as described in EP 0 227 141A1 (Leenders et al.), silver salts of aryl carboxylic acids (such as silver benzoate), silver salts of acetylenes as described, for example in U.S. Pat. No. 4,761,361 (Ozaki et al.) and U.S. Pat. No. 4,775,613 (Hirai et al.), and silver salts of heterocyclic compounds containing mercapto or thione groups and derivatives as described in U.S. Pat. No. 4,123,274 (Knight et al.) and U.S. Pat. No. 3,785,830 (Sullivan et al.).

It is also convenient to use silver half soaps such as an equimolar blend of silver carboxylate and carboxylic acid that analyzes for about 14.5% by weight solids of silver in the blend and that is prepared by precipitation from an aqueous solution of an ammonium or an alkali metal salt of a commercially available fatty carboxylic acid, or by addition of the free fatty acid to the silver soap.

The methods used for making silver soap emulsions are well known in the art and are disclosed in Research Disclosure, April 1983, item 22812, Research Disclosure, October 1983, item 23419, U.S. Pat. No. 3,985,565 (Gabrielsen et al.) and the references cited above.

Sources of non-photosensitive reducible silver ions can also be core-shell silver salts as described in U.S. Pat. No. 6,355,408 (Whitcomb et al.), wherein a core has one or more silver salts and a shell has one or more different silver salts, as long as one of the silver salts is a silver carboxylate. Other useful sources of non-photosensitive reducible silver ions are the silver dimer compounds that comprise two different silver salts as described in U.S. Pat. No. 6,472,131 (Whitcomb). Still other useful sources of non-photosensitive reducible silver ions are the silver core-shell compounds comprising a primary core comprising one or more photosensitive silver halides, or one or more non-photo-sensitive inorganic metal salts or non-silver containing organic salts, and a shell at least partially covering the primary core, wherein the shell comprises one or more non-photosensitive silver salts, each of which silver salts comprises a organic silver coordinating ligand. Such compounds are described in U.S. Pat. No. 6,803,177 (Bokhonov et al.).

Organic silver salts that are particularly useful in organic solvent-based thermographic and photothermographic materials include silver carboxylates (both aliphatic and aryl carboxylates), silver benzotriazolates, silver sulfonates, silver sulfosuccinates, and silver acetylides. Silver salts of long-chain aliphatic carboxylic acids containing 15 to 28 carbon atoms and silver salts of benzotriazoles are particularly preferred. Silver carboxylates containing silver behenate are most preferred.

Organic silver salts that are particularly useful in aqueous based thermographic and photothermographic materials include silver salts of compounds containing an imino group. Preferred examples of these compounds include, but are not limited to, silver salts of benzotriazole and substituted derivatives thereof (for example, silver methylbenzotriazole and silver 5-chloro-benzotriazole), silver salts of 1,2,4-triazoles or 1 -H-tetrazoles such as phenyl-mercaptotetrazole as described in U.S. Pat. No. 4,220,709 (deMauriac), and silver salts of imidazoles and imidazole derivatives as described in U.S. Pat. No. 4,260,677 (Winslow et al.). Particularly useful silver salts of this type are the silver salts of benzotriazole and substituted derivatives thereof. A silver salt of a benzotriazole is particularly preferred in aqueous-based thermographic and photo-thermographic formulations.

Useful nitrogen-containing organic silver salts and methods of preparing them are described in U.S. Pat. No. 6,977,139 (Hasberg et al.). Such silver salts (particularly the silver benzotriazoles) are rod-like in shape and have an average aspect ratio of at least 3:1 and a width index for particle diameter of 1.25 or less. Silver salt particle length is generally less than 1 μm. Also useful are the silver salt-toner co-precipitated nano-crystals comprising a silver salt of a nitrogen-containing heterocyclic compound containing an imino group, and a silver salt comprising a silver salt of a mercaptotriazole. Such co-precipitated salts are described in U.S Pat. No. 7,008,748 (Hasberg et al.).

The one or more non-photosensitive sources of reducible silver ions are preferably present in an amount of from about 5% to about 70%, and more preferably from about 10% to about 50%, based on the total dry weight of the emulsion layers. Alternatively stated, the amount of the sources of reducible silver ions is generally from about 0.002 to about 0.2 mol/m² of the dry photo-thermographic material (preferably from about 0.01 to about 0.05 mol/m²).

The total amount of silver (from all silver sources) in the thermo-graphic and photothermographic materials is generally at least 0.002 mol/m², preferably from about 0.01 to about 0.05 mol/m², and more preferably from about 0.01 to about 0.02 mol/m². In other aspects, it is desirable to use total silver [from both silver halide (when present) and reducible silver salts] at a coating weight of less than 2.5 g/m², preferably at least I but less than 2.0 g/m², and more preferably equal to or less than 1.9 g/m2 especially in photothermographic materials.

### Reducing Agent Combination

The reducing agent combination for the source of reducible silver ions comprises at least one trisphenol represented by the following Structure (I), and

(a) at least one monophenol represented by the following Structure (II) or at least one bisphenol represented by the following Structure (III), or

(b) at least one monophenol represented by the following Structure (II) and at least one bisphenol represented by the following Structure (III):

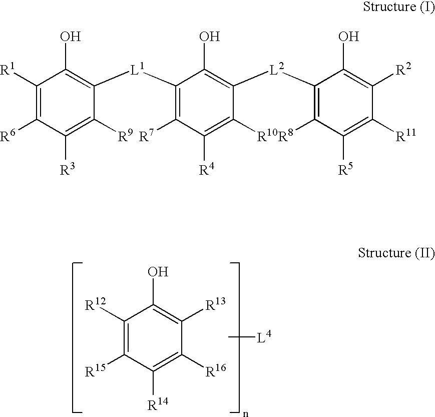

wherein L¹, L², and L³ are independently sulfur or a mono-substituted or unsubstituted methylene group, R¹ and R² are independently primary or secondary substituted or unsubstituted alkyl groups having 1 to 12 carbon atoms that can be linear, branched or cyclic (such as methyl, ethyl, n-propyl, iso-propyl, iso-butyl, cyclohexyl, benzyl, 4-methylcyclohexyl, norbomyl, or isobomyl),

R³, R⁴, R⁵, R¹⁹, and R²⁰ are independently substituted or unsubstituted alkyl groups having 1 to 12 carbon atoms (such as methyl, ethyl, n-propyl, iso-propyl, iso-butyl, tert-butyl, cyclohexyl, benzyl, 4-methyl-cyclohexyl, norbomyl, or isobomyl), substituted or unsubstituted alkoxy groups having 1 to 12 carbon atoms (such as methoxy, ethoxy, propoxy, iso-propoxy, or n-butoxy), or halo groups (such as chloro or bromo),

R⁶, R⁷, R⁸, R⁹, R¹⁰, R¹¹, R²¹, R²², R²³, and R²⁴ are independently hydrogen or any substituent that is substitutable on a benzene ring,

R¹² and R¹³ are independently substituted or unsubstituted alkyl groups having 1 to 12 carbon atoms exclusive of 2-hydroxyphenylmethyl group, (such as methyl, ethyl, n-propyl, iso-propyl, iso-butyl, tert-butyl, 1-methylcyclohexyl, cyclohexyl, benzyl, tert-pentyl, norbomyl, or isobomyl), substituted or unsubstituted alkoxy groups having 1 to 12 carbon atoms (as defined above), halo groups (such as chloro or bromo), or hydrogen, such that both R¹² and R¹³ are not both simultaneously hydrogen,

R¹⁴, R¹⁵, and R¹⁶ are independently hydrogen, or any substituent that is substitutable on a benzene ring,

R¹⁷ and R¹⁸ are independently substituted or unsubstituted alkyl groups having 1 to 12 carbon atoms (as defined above for R¹² and R¹³),

n is an integer of 1 or greater, and

when n is 2 or greater, L⁴ is a single bond or a linking group that is attached to any of R¹², R¹³, R¹⁴, R¹⁵, or R¹⁶.

Preferably, L¹, L², and L³ are independently methylene groups or mono-substituted methylene groups (for example, a mono-substituted methylene group substituted with one alkyl group, aryl group, cycloalkyl group, or heterocyclic group),

R¹ and R² are independently substituted or unsubstituted primary or secondary alkyl groups having 1 to 8 carbon atoms,

R³, R⁴, R⁵, R⁹, and R²⁰ are independently substituted or unsubstituted alkyl groups having 1 to 6 carbon atoms,

R⁶, R⁷, R⁸, R⁹, R¹⁰, R¹¹, R¹⁵, R¹⁶, R²¹, R²², R²³, and R²⁴are independently hydrogen, or substituted or unsubstituted methyl, ethyl, or methoxy groups, or chloro groups,

R¹², R¹³, R¹⁷, and R¹⁸ are independently substituted or unsubstituted primary, secondary, or tertiary alkyl groups having 1 to 7 carbon atoms, and

R¹⁴ is a substituted or unsubstituted alkyl group having 1 to 4 carbon atoms, and

n is 1 to 4, provided that when n is 2 or greater, L⁴ is a single bond or a linking group that is attached to any of R¹⁴, R¹⁵, R¹⁶.

More preferably, L¹, L², and L³ are unsubstituted methylene groups,

R¹ and R² are the same substituted or unsubstituted primary or secondary alkyl groups having 1 to 6 carbon atoms,

R³, R⁴, R⁵, R¹⁹, and R²⁰ are the same substituted or unsubstituted methyl or ethyl groups,

R⁶ ,R⁷, R⁸, R⁹, R¹⁰, R¹¹, R¹⁵, R¹⁶, R²¹, R²², R²³, and R²⁴ are independently hydrogen or unsubstituted methyl groups,

R¹², R¹³, R¹⁷, and R¹⁸ are independently substituted or unsubstituted secondary or tertiary alkyl groups having 3 to 7 carbon atoms, and

R¹⁴is a substituted or unsubstituted alkyl group having 1 to 4 carbon atoms, or in some embodiments, R¹⁴ is a group represented by —CH₂CH₂(C═O)— and L⁴ is a group represented by (—OCH₂)₄C-, particularly when n is 4.

One skilled in the art would understand that when n is 1, L⁴ is not present.

Compounds (I-1) to (I-18) in TABLE I are representative of the trisphenol reducing agents represented by Structure (I) that are useful in the present invention. Compounds (II-1) to (II-17) in TABLE II are representative of the monophenol reducing agents represented by Structure (II) that are useful in the present invention. Compounds (III-1) to (III-18) in TABLE III are representative of the bisphenol reducing agents represented by Structure (III) that are useful in the present invention. Of these listed compounds, Compounds I-2 and I-3 of TABLE I, Compounds II-8 and II-17 of TABLE II, and Compounds III-1 and III-4 of TABLE III, are preferred.

Preferred combinations of reducing agents useful in this invention include combinations of either or both of Compounds I-2 and I-3 of TABLE I with either or both of Compounds II-8 and II-17 of TABLE II. Other preferred combinations include combinations of either or both of Compounds I-2 and I-3 of TABLE I with either or both of Compounds III-1 and III-4 of TABLE III. Still other preferred combinations include combinations of either or both of Compounds I-2 and I-3 of TABLE I with either or both of Compounds II-8 and II-17 of TABLE II and either or both of Compounds III-1 and III-4 of TABLE III.

TABLE I

| Compound | R₁, R₂ | R₃, R₅ | R₄ | L¹, L² |
|---|---|---|---|---|
| I-1 | CH₃ | t-C₄H₉ | CH₃ | CH₂ |
| I-2 | CH₃ | CH₃ | CH₃ | CH₂ |
| I-3 | Cyclohexyl | CH₃ | CH₃ | CH₂ |
| I-4 | Isobornyl | CH₃ | CH₃ | CH₂ |
| I-5 | CH₃ | CH₃ | CH₃ | CH(C₃H₇) |
| I-6 | C₂H₅ | CH₃ | CH₃ | CH₂ |
| I-7 | CH₃ | C₂H₅ | CH₃ | CH₂ |
| I-8 | CH₃ | CH₃ | t-C₄H₉ | CH₂ |
| I-9 | CH₃ | CH₃ | C₂H₅ | CH₂ |
| I-10 | CH₃ | CH₃ | OCH₃ | CH₂ |
| I-11 | CH₃ | CH₃ | Cl | CH₂ |
| I-12 | Norbornyl | CH₃ | CH₃ | CH₂ |
| I-13 | CH₃ | CH₃ | CH₃ | CH(CH₂CH₂C₆H₅) |
| I-14 | i-(C₃H₇) | CH₃ | CH₃ | CH₂ |
| I-15 | Cyclopentyl | CH₃ | CH₃ | CH₂ |
| I-16 | CH₃ | CH₂CH₂OH | CH₃ | CH₂ |
| I-17 | CH₃ | CH₃ | CH₃ | CH(CH₂CH₂CH₂OH) |
| I-18 | CH₃ | CH₃ | Cyclohexyl | CH₂ |

TABLE II

| Compound | R¹², R¹³ | R¹⁴ | R¹⁵, R¹⁶ | L⁴ | n |
|---|---|---|---|---|---|
| II-1 | t-C₄H₉ | CH₃ | H | Nil | 1 |
| II-2 | t-C₄H₉ | t-C₄H₉ | H | Nil | 1 |
| II-3 | t-C₄H₉, CH₃ | CH₃ | H | Nil | 1 |
| II-4 | t-C₄H₉ | COOCH₃ | H | Nil | 1 |
| II-5 | t-C₄H₉ | COOC₁₈H₃₇ | H | Nil | 1 |
| II-6 | t-C₅H₁₁ | CH₃ | H | Nil | 1 |
| II-7 | t-C₄H₉ | C₉H₁₉ | H | Nil | 1 |
| II-8 | t-C₄H₉ | CH₂CH₂(C═O)— | H | (—OCH₂)₄C | 4 |
| II-9 | t-C₄H₉ | CH₂CH₂(C═O)— | H | 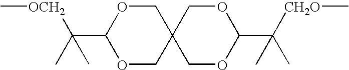 | 2 |
| II-10 | t-C₄H₉ | CH₂— | H | single bond | 2 |
| II-11 | t-C₄H₉ | CH₂CH₂(C═O)— | H | —OCH₂CH₂O— | 2 |
| II-11 | t-C₄H₉ | CH₂CH₂(C═O)— | H | (—OCH₂)₃CCH₂CH₃ | 3 |
| II-12 | t-C₄H₉ | CH₂CH₂O— | H | 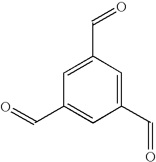 | 3 |
| II-13 | t-C₄H₉ | CH₂CH₂(C═O)— | H | 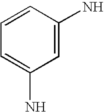 | 2 |
| II-14 | t-C₄H₉ | CH₂CH₂— | H | single bond | 2 |
| II-15 | t-C₄H₉ | CH₂— | H | 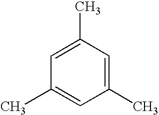 | 3 |
| II-16 | t-C₄H₉ | CH₂CH₂(C═O)— | H | OCH₂CH₂—S—CH₂CH₂O | 2 |
| II-17 | t-C₄H₉, CH₃ | CH₃ | CH₂—, H | 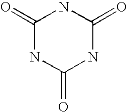 | 3 |

TABLE III

| Compound | R₁₇, R₁₈ | R₁₉, R₂₀ | L³ |
|---|---|---|---|
| III-1 | t-C₄H₉ | CH₃ | CH₂ |
| III-2 | CH₃ | CH₃ | CH(CH₂CH₂C₆H₅) |
| III-3 | CH₃ | CH₃ | CH(Cyclohexyl) |
| III-4 | 1-CH₃(Cyclohexyl) | CH₃ | CH₂ |
| III-5 | Isobornyl | CH₃ | CH₂ |
| III-6 | Norbornyl | CH₃ | CH₂ |
| III-7 | CH₃ | CH₃ | CH(i-C₃H₇) |
| III-8 | CH₃ | C₂H₅ | CH₂ |
| III-9 | t-C₄H₉ | CH₃ | S |
| III-10 | t-C₅H₁₁ | CH₃ | CH₂ |
| III-11 | Cyclohexyl | CH₃ | CH₂ |
| III-12 | t-C₄H₉ | CH₂CH₂OH | CH₂ |
| III-13 | t-C₄H₉ | CH₃ | CH(CH₂CH₂CH₂OH) |
| III-14 | t-C₄H₉ | CH₃ | CH(CH₂CH₂CH₃) |
| III-15 | t-C₄H₉ | t-C₄H₉ | CHCH₃ |
| III-16 | CH₃ | CH₂OCH₃ | CH(CH₂CH₂CH₃) |
| III-17 | CH₃ | CH₃ | CH₂(C₃H₇) |
| III-18 | CH₃ | CH₃ | CH(CH₂CH(CH₃)CH₂C(CH₃)₃) |

The various phenols represented by Structures I, II, and III can be obtained from a number of commercial sources, including Aldrich Chemical Company (Milwaukee, Wis.), or they can be prepared using known synthetic methods. For example, the trisphenols represented by Structure (I) can be prepared by the procedures described in D. J. Beaver et al., J. Amer Chem. Soc., 1953, 75, 5579-81.

The mixture of phenolic reducing agents represented by the compounds of Structures I, II, and III generally provides from about 1 to about 45% (dry weight) of the emulsion layer in which it is located. In multilayer constructions, if the reducing agent(s) is added to a layer other than an emulsion layer, slightly higher proportions, of from about 2 to 55 weight % may be more desirable. Thus, the total range for the total amount of phenolic reducing agents can be from about 1 to about 55 % (dry weight). Also, these phenolic reducing agents are generally present in an amount of at least 0.05 and up to and including about 0.5 mol/mol of total silver in the thermally developable material, and preferably in an amount of from about 0.1 to about 0.4 mol/mol of total silver. Other additional reducing agents (described below) that may be present could contribute additional amounts of overall reducing agents to the imaging chemistry.

The molar ratio of the reducing agent of Structure (I) to the total reducing agents of Structure (II) or (III), or to the total reducing agents of both Structures (II) and (III), is from about 0.1:1 to about 50: 1, and preferably from about 0.1: 1 to about 10:1. The amount of the reducing agent of Structure (I) is generally from about 0.5 to about 30 % (dry weight of the layer), or from about 0.05 to about 0.5 mol/mol of total silver, and preferably is from about 1 to about 10% (dry weight) or from about 0.05 to about 0.25 mol/mol of total silver.

Additional reducing agents include the bisphenol-phosphorous compounds described in U.S. Pat. No. 6,514,684 (Suzuki et al), the bisphenol, aromatic carboxylic acid, hydrogen bonding compound mixture described in U.S. Pat. No. 6,787,298 (Yoshioka), and the compounds that can be one-electron oxidized to provide a one-electron oxidation product that releases one or more electrons as described in U.S. Patent Application Publication 2005/0214702 (Ohzeki). Other reducing agents that can be used include substituted hydrazines such as the sulfonyl hydrazides described in U.S. Pat. No. 5,464,738 (Lynch et al.). Still other useful reducing agents are described in U.S. Pat. No. 3,074,809 (Owen), U.S. Pat. No. 3,080,254 (Grant, Jr.), U.S. Pat. No. 3,094,417 (Workman), U.S. Pat. No. 3,887,417 (Klein et al.), U.S. Pat. No. 4,030,931 (Noguchi et al.), and U.S. Pat. No. 5,981,151 (Leenders et al.).

Additional reducing agents that may be used along with the reducing agent mixture described above, include amidoximes, azines, a combination of aliphatic carboxylic acid aryl hydrazides and ascorbic acid, a reductone and/or a hydrazine, piperidinohexose reductone or formyl-4-methylphenylhydrazine, hydroxamic acids, a combination of azines and sulfonamidophenols, α-cyanophenylacetic acid derivatives, reductones, indane-1,3-diones, chromans, 1,4-dihydropyridines, and 3-pyrazolidones.

Reducing agent mixtures including high contrast enhancing agents are also useful. Such materials are useful for preparing printing plates and duplicating films useful in graphic arts, or for nucleation of medical diagnostic films. These “high contrast enhancing agents” are also identified in the art as “contrast enhancing agents”, “nucleating agents”, and “silver saving agents”. Examples of such compounds are described in U.S. Pat. No. 6,150,084 (Ito et al.) and U.S. Pat. No. 6,620,582 (Hirabayashi). Certain contrast enhancing agents are preferably used in some thermographic and photothermographic materials with specific reducing agents and the co-developers described herein. Examples of such useful high contrast enhancing agents include, but are not limited to, hydroxylamines, alkanolamines and ammonium phthalamate compounds as described in U.S. Pat. No. 5,545,505 (Simpson), hydroxamic acid compounds as described for example, in U.S. Pat. No. 5,545,507 (Simpson et al.), N-acylhydrazine compounds as described in U.S. Pat. No. 5,558,983 (Simpson et al.), and hydrogen atom donor compounds as described in U.S. Pat. No. 5,637,449 (Harring et al.), all of which patents are incorporated herein by reference. It would be understood by one skilled in the art that such compounds may have varying effectiveness depending upon the imaging chemistry in which they are used and the amount at which they are used, and that they also may have multiple properties, for example, acting as co-developers as well as enhancing contrast.

The high contrast enhancing agents can be present in an amount of from about 0.0005 to about 1 g/m² and preferably from about 0.001 to about 0.5 g/m².

### Co-Developers

In addition to the reducing agent mixture described above, the thermally developable materials may also contain one or more co-developer compounds. “Co-developers” are organic compounds that by themselves do not act as effective reducing agents for the non-photosensitive silver salt, but when used in combination with a reducing agent and a non-photosensitive silver salt provide, upon development, increased silver development. This results in increased optical density (Dₘₐₓ) and improved Silver Efficiency.

Thus, in some instances, the reducing agent composition comprises in addition to the reducing agent combination, one or more co-developers (also known as co-reducing agents). Such contrast enhancing agents can be chosen from the various classes of reducing agents described below.

Classes of co-developers that can be used in combination with the inventive co-developers described herein are trityl hydrazides and formyl phenyl hydrazides as described in U.S. Pat. No. 5,496,695 (Simpson et al.). Yet another class of co-developers includes substituted acrylonitrile compounds such as those described in U.S. Pat. No. 5,545,515 (Murray et al.) and U.S. Pat. No. 5,635,339 (Murray). Also useful are the crown ether-alkali metal complex cation of an enolate anion of an aldehyde having at least one electron withdrawing group in the alpha (α) position, as described in copending and commonly assigned U.S. Ser. No. 11/455,415 (filed Jun. 19, 2006 by Kumars Sakizadeh and Sharon M. Simpson). These patents and patent application are incorporated herein by reference.

One or more co-developer compounds can be added to any layer on the side of the support having a thermally developable thermographic or photo-thermographic emulsion layer as long as they are allowed to come into intimate contact with the emulsion layer during coating, drying, storage, thermal development, or post-processing storage. Thus one or more co-developer compounds can be added directly to the thermally developable thermographic or photothermographic emulsion layer or to one or more overcoat layers above the emulsion layer (for example a topcoat layer, interlayer, or barrier layer) and/or below the emulsion layer (such as to a primer layer, subbing layer, or carrier layer). Preferably one or more co-developer compounds are added directly to the emulsion layer or to an overcoat layer and allowed to diffuse into the emulsion layer.

Where the photothermographic material has one or more photo-thermographic layers on both sides of the support, one or more of the same or different co-developer compounds can be used on one or both sides of the support.

Generally, one or more co-developer compounds are present in a total amount of at least 0.0005 g/m² in one or more layers on the imaging side of the support, of the emulsion layer into which they are incorporated or diffused. The co-developers are preferably present in a total amount of from about 0.0005 g/m² to about 0.15 g/m2, and preferably present in a total amount of from about 0.001 to about 0.05 g/m² in one or more layers on an imaging side of the support. The molar ratio of reducing agent combination to co-developer is generally from about 5,000: 1 to about 10: 1, preferably from about 1000:1 to about 100:1.

Ternary mixtures comprising the reducing agent combination, one or more co-developers, and one or more high contrast enhancing agents are also useful.

### Other Addenda

The thermally developable materials can also contain other additives such as shelf-life stabilizers, antifoggants, contrast enhancers (described above), toners, development accelerators, acutance dyes, post-processing stabilizers or stabilizer precursors, thermal solvents (also known as melt formers), antistatic or conductive layers, and other image-modifying agents as would be readily apparent to one skilled in the art.

Suitable stabilizers that can be used alone or in combination include thiazolium salts as described in U.S. Pat. No. 2,131,038 (Brooker) and 2,694,716 (Allen), azaindenes as described in U.S. Pat. No. 2,886,437 (Piper), triazaindolizines as described in U.S. Pat. No. 2,444,605 (Heimbach), the urazoles described in U.S. Pat. No. 3,287,135 (Anderson), sulfocatechols as described in U.S. Pat. No. 3,235,652 (Kennard), the oximes described in GB 623,448 (Carrol et al.), polyvalent metal salts as described in U.S. Pat. No. 2,839,405 (Jones), thiuronium salts as described in U.S. Pat. No. 3,220,839 (Herz), palladium, platinum, and gold salts as described in U.S. Pat. No. 2,566,263 (Trirelli) and U.S. Pat. No. 2,597,915 (Damshroder), and the heteroaromatic mercapto compounds or heteroaromatic disulfide compounds described in EP 0 559 228B1 (Philip et al.).

Heteroaromatic mercapto compounds are most preferred. Preferred heteroaromatic mercapto compounds include 2-mercaptobenzimidazole, 2-mercapto-5-methylbenzimidazole, 2-mercaptobenzothiazole and 2-mercapto-benzoxazole, and mixtures thereof. A heteroaromatic mercapto compound is generally present in an emulsion layer in an amount of at least 0.0001 mole (preferably from about 0.001 to about 1.0 mole) per mole of total silver in the emulsion layer.

Other useful antifoggants/stabilizers are described in U.S. Pat. No. 6,083,681 (Lynch et al.). Still other antifoggants are hydrobromic acid salts of heterocyclic compounds (such as pyridinium hydrobromide perbromide) as described in U.S. Pat. No. 5,028,523 (Skoug), benzoyl acid compounds as described in U.S. Pat. No. 4,784,939 (Pham), substituted propenenitrile compounds as described in U.S. Pat. No. 5,686,228 (Murray et al.), silyl blocked compounds as described in U.S. Pat. No. 5,358,843 (Sakizadeh et al.), the 1,3-diaryl-substituted urea compounds described copending and commonly assigned U.S. Patent Application Publication 2007/0117053 (Hunt et al.), and tribromo-methylketones as described in EP 0 600 587A1 (Oliffet al.).

Additives useful as stabilizers for improving dark stability and desktop print stability are the various boron compounds described in U.S. Patent Application Publication 2006/0141404 (Philip et al.). The boron compounds are preferably added in an amount of from about 0.010 to about 0.50 g/m².

Also useful as stabilizers for improving the post-processing print stability of the imaged material to heat during storage (known as “hot-dark print stability”) are the arylboronic acid compounds described in copending and commonly assigned U.S. Ser. No. 11/351,773 (filed on Feb. 10, 2006 by Chen-Ho and Sakizadeh).

The photothermographic materials preferably also include one or more polyhalogen stabilizers that can be represented by the formula Q-(Y)ₙ—C(Z₁Z₂X) wherein, Q represents an alkyl, aryl (including heteroaryl) or heterocyclic group, Y represents a divalent linking group, n represents 0 or 1, Z₁ and Z₂ each represents a halogen atom, and X represents a hydrogen atom, a halogen atom, or an electron-withdrawing group. Particularly useful compounds of this type are polyhalogen stabilizers wherein Q represents an aryl group, Y represents (C═O) or SO₂, n is 1, and Z₁, Z₂, and X each represent a bromine atom. Examples of such compounds containing —SO₂CBr₃ groups are described in U.S. Pat. No. 3,874,946 (Costa et al.), U.S. Pat. No. 5,369,000 (Sakizadeh et al.), U.S. Pat. No. 5,374,514 (Kirk et al.), U.S. Pat. No. 5,460,938 (Kirk et al.), U.S. Pat. No. 5,464,747 (Sakizadeh et al.) and U.S. Pat. No. 5,594,143 (Kirk et al.). Examples of such compounds include, but are not limited to, 2-tribromomethylsulfonyl-5-methyl-1,3,4-thiadiazole, 2-tribromomethylsulfonyl-pyridine, 2-tribromomethylsulfonylquinoline, and 2-tribromomethylsulfonyl-benzene. The polyhalogen stabilizers can be present in one or more layers in a total amount of from about 0.005 to about 0.01 mol/mol of total silver, and preferably from about 0.01 to about 0.05 mol/mol of total silver.

Stabilizer precursor compounds capable of releasing stabilizers upon application of heat during imaging can also be used, as described in U.S. Pat. No. 5,158,866 (Simpson et al.), U.S. Pat. No. 5,175,081 (Krepski et al.), 5,298,390 (Sakizadeh et al.), and U.S. Pat. No. 5,300,420 (Kenney et al.). Also useful are the blocked aliphatic thiol compounds described in U.S. Patent Application Publication 2006/0141403 (Ramsden et al.).

In addition, certain substituted-sulfonyl derivatives of benzo-triazoles may be used as stabilizing compounds as described in U.S. Pat. No. 6,171,767 (Kong et al.).

“Toners” or derivatives thereof that improve the image are desirable components of the thermally developable materials. These compounds, when added to the imaging layer, shift the color of the image from yellowish-orange to brown-black or blue-black. Generally, one or more toners described herein are present in an amount of from about 0.01% to about 10% (more preferably from about 0.1% to about 10%), based on the total dry weight of the layer in which the toner is included. Toners may be incorporated in the thermographic or photothermographic emulsion or in an adjacent non-imaging layer.

Compounds useful as toners are described in U.S. Pat. No. 3,080,254 (Grant, Jr.), U.S. Pat. No. 3,847,612 (Winslow), U.S. Pat. No. 4,123,282 (Winslow), U.S. Pat. No. 4,082,901 (Laridon et al.), U.S. Pat. No. 3,074,809 (Owen), U.S. Pat. No. 3,446,648 (Workman), 3,844,797 (Willems et al.), U.S. Pat. No. 3,951,660 (Hagemann et al.), U.S. Pat. No. 5,599,647 (Defieuw et al.) and GB 1,439,478 (AGFA).

Additional useful toners are substituted and unsubstituted mercaptotriazoles as described in U.S. Pat. No. 3,832,186 (Masuda et al.), U.S. Pat. No. 6,165,704 (Miyake et al.), U.S. Pat. No. 5,149,620 (Simpson et al.), U.S. Pat. No. 6,713,240 (Lynch et al.), and U.S. Pat. No. 6,841,343 (Lynch et al.).

Phthalazine and phthalazine derivatives [such as those described in U.S. Pat. No. 6,146,822 (Asanuma et al.)], phthalazinone, and phthalazinone derivatives are particularly useful toners.

A combination of one or more hydroxyphthalic acids and one or more phthalazinone compounds can be included in the thermographic materials. Hydroxyphthalic acid compounds have a single hydroxy substituent that is in the meta position to at least one of the carboxy groups. Preferably, these compounds have a hydroxy group in the 4-position and carboxy groups in the 1- and 2-positions. The hydroxyphthalic acids can be further substituted in other positions of the benzene ring as long as the substituents do not adversely affect their intended effects in the thermographic material. Mixtures of hydroxyphthalic acids can be used if desired.

Useful phthalazinone compounds are those having sufficient solubility to completely dissolve in the formulation from which they are coated. Preferred phthalazinone compounds include 6,7-dimethoxy-1-(2H)-phthalazinone, 4-(4-pentylphenyl)-1-(2H)-phthalazinone, and 4-(4-cyclohexylphenyl)-1-(2H)-phthalazinone. Mixtures of such phthalazinone compounds can be used if desired.

This combination facilitates obtaining a stable bluish-black image after processing. In preferred embodiments, the molar ratio of hydroxyphthalic acid to phthalazinone is sufficient to provide an a* value more negative than −2 (preferably more negative than −2.5) at an optical density of 1.2 as defined by the CIELAB Color System when the material has been imaged using a thermal print-head from 300 to 400° C. for less than 50 milliseconds (50 msec) and often less than 20 msec. In preferred embodiments, the molar ratio of phthalazinone is to hydroxyphthalic acid about 1:1 to about 3:1. More preferably the ratio is from about 2:1 to about 3:1.

In addition, the imaged material provides an image with an a* value more negative than −1 at an optical density of 1.2 as defined by the CIELAB Color System when the above imaged material is then stored at 70° C. and 30% RH for 3 hours.

The thermographic materials may also include one or more additional polycarboxylic acids (other than the hydroxyphthalic acids noted above) and/or anhydrides thereof that are in thermal working relationship with the sources of reducible silver ions in the one or more thermographic layers. Such polycarboxylic acids can be substituted or unsubstituted aliphatic (such as glutaric acid and adipic acid) or aromatic compounds and can be present in an amount of at least 5 mol % ratio to silver. They can be used in anhydride or partially esterified form as long as two free carboxylic acids remain in the molecule. Useful polycarboxylic acids are described for example in U.S. Pat. No. 6,096,486 (Emmers et al.).

The addition of development accelerators that increase the rate of image development and allow reduction in silver coating weight is also useful. Suitable development accelerators include phenols, naphthols, and hydrazine-carboxamides. Such compounds are described, for example, in Y. Yoshioka, K. Yamane, T. Ohzeki, Development of Rapid Dry Photothermographic Materials with Water-Base Emulsion Coating Method, AgX 2004: The International Symposium on Silver Halide Technology “At the Forefront of Silver Halide Imaging”, Final Program and Proceedings of IS&T and SPSTJ, Ventura, Calif., Sept. 13-15, 2004, pp. 28-31, Society for Imaging Science and Technology, Springfield, Va., U.S. Pat. No. 6,566,042 (Goto et al.), U.S. Patent Application Publications 2004/234906 (Ohzeki et al.), 2005/048422 (Nakagawa), 2005/118542 (Mori et al.), (Nakagawa), and 2006/0014111 (Goto).

Thermal solvents (or melt formers) can also be used, including combinations of such compounds (for example, a combination of succinimide and dimethylurea). Thermal solvents are compounds which are solids at ambient temperature but which melt at the temperature used for processing. The thermal solvent acts as a solvent for various components of the heat-developable photosensitive material, it helps to accelerate thermal development and it provides the medium for diffusion of various materials including silver ions and/or complexes and reducing agents. Known thermal solvents are disclosed in U.S. Pat. No. 3,438,776 (Yudelson), U.S. Pat. No. 5,064,753 (noted above) U.S. Pat. No. 5,250,386 (Aono et al.), U.S. Pat. No. 5,368,979 (Freedman et al.), U.S. Pat. No. 5,716,772 (Taguchi et al.), and U.S. Pat. No. 6,013,420 (Windender). Thermal solvents are also described in U.S. Pat. No. 7,169,544 (Chen-Ho et al.).

The photothermographic materials can also include one or more image stabilizing compounds that are usually incorporated in a “backside” layer. Such compounds can include phthalazinone and its derivatives, pyridazine and its derivatives, benzoxazine and benzoxazine derivatives, benzothiazine dione and its derivatives, and quinazoline dione and its derivatives, particularly as described in U.S. Pat. No. 6,599,685 (Kong). Other useful backside image stabilizers include anthracene compounds, coumarin compounds, benzophenone compounds, benzotriazole compounds, naphthalic acid imide compounds, pyrazoline compounds, or compounds described in U.S. Pat. No. 6,465,162 (Kong et al), and GB 1,565,043 (Fuji Photo).

Phosphors are materials that emit infrared, visible, or ultraviolet radiation upon excitation and can be incorporated into the photothermographic materials. Particularly useful phosphors are sensitive to X-radiation and emit radiation primarily in the ultraviolet, near-ultraviolet, or visible regions of the spectrum (that is, from about 100 to about 700 nm). An intrinsic phosphor is a material that is naturally (that is, intrinsically) phosphorescent. An “activated” phosphor is one composed of a basic material that may or may not be an intrinsic phosphor, to which one or more dopant(s) has been intentionally added. These dopants or activators “activate” the phosphor and cause it to emit ultraviolet or visible radiation. Multiple dopants may be used and thus the phosphor would include both “activators” and “co-activators”.

Any conventional or useful phosphor can be used, singly or in mixtures. For example, useful phosphors are described in numerous references relating to fluorescent intensifying screens as well as U.S. Pat. No. 6,440,649 (Simpson et al.) and U.S. Pat. No. 6,573,033 (Simpson et al.) that are directed to photothermo-graphic materials. Some particularly useful phosphors are primarily “activated” phosphors known as phosphate phosphors and borate phosphors. Examples of these phosphors are rare earth phosphates, yttrium phosphates, strontium phosphates, or strontium fluoroborates (including cerium activated rare earth or yttrium phosphates, or europium activated strontium fluoroborates) as described in U.S. Patent Application Publication 2005/0233269 (Simpson et al.).

The one or more phosphors can be present in the photothermo-graphic materials in an amount of at least 0.1 mole per mole, and preferably from about 0.5 to about 20 mole, per mole of total silver in the photothermographic material. As noted above, generally, the amount of total silver is at least 0.002 mol/m². While the phosphors can be incorporated into any imaging layer on one or both sides of the support, it is preferred that they be in the same layer(s) as the photosensitive silver halide(s) on one or both sides of the support

### Binders

The photosensitive silver halide (when present), the non-photo-sensitive source of reducible silver ions, the reducing agent composition, and any other imaging layer additives are generally combined with one or more binders that are generally hydrophobic or hydrophilic in nature. Thus, either aqueous or organic solvent-based formulations can be used to prepare the thermally developable materials. Mixtures of either or both types of binders can also be used. It is preferred that the binder be selected from predominantly hydrophobic polymeric materials (at least 50 dry weight % of total binders).

Examples of typical hydrophobic binders include polyvinyl acetals, polyvinyl chloride, polyvinyl acetate, cellulose acetate, cellulose acetate butyrate, polyolefins, polyesters, polystyrenes, polyacrylonitrile, polycarbonates, methacrylate copolymers, maleic anhydride ester copolymers, butadiene-styrene copolymers, and other materials readily apparent to one skilled in the art. Copolymers (including terpolymers) are also included in the definition of polymers. The polyvinyl acetals (such as polyvinyl butyral, polyvinyl acetal, and polyvinyl formal) and vinyl copolymers (such as polyvinyl acetate and polyvinyl chloride) are particularly preferred. Particularly suitable hydrophobic binders are polyvinyl butyral resins that are available under the names MOWITAL® (Kuraray America, New York, N.Y.), S-LEC® (Sekisui Chemical Company, Troy, Mich.), BUTVAR® (Solutia, Inc., St. Louis, Mo.) and PIOLOFORM® (Wacker Chemical Company, Adrian, Mich.).

Hydrophilic binders or water-dispersible polymeric latex polymers can also be present in the formulations. Examples of useful hydrophilic binders include, but are not limited to, proteins and protein derivatives, gelatin and gelatin-like derivatives (hardened or unhardened), cellulosic materials such as hydroxymethyl cellulose and cellulosic esters, acrylamide/methacrylamide polymers, acrylic/methacrylic polymers polyvinyl pyrrolidones, polyvinyl alcohols, poly(vinyl lactams), polymers of sulfoalkyl acrylate or methacrylates, hydrolyzed polyvinyl acetates, polyacrylamides, polysaccharides and other synthetic or naturally occurring vehicles commonly known for use in aqueous-based photographic emulsions (see for example, Research Disclosure, item 38957, noted above). Cationic starches can also be used as a peptizer for tabular silver halide grains as described in U.S. Pat. No. 5,620,840 (Maskasky) and U.S. Pat. No. 5,667,955 (Maskasky).

One embodiment of the polymers capable of being dispersed in aqueous solvent includes hydrophobic polymers such as acrylic polymers, poly(ester), rubber (e.g., SBR resin), poly(urethane), poly(vinyl chloride), poly(vinyl acetate), poly(vinylidene chloride), poly(olefin), and the like. As the polymers above, usable are straight chain polymers, branched polymers, or crosslinked polymers. Also usable are the so-called homopolymers in which single monomer is polymerized, or copolymers in which two or more types of monomers are polymerized. In the case of a copolymer, it may be a random copolymer or a block copolymer. The molecular weight of these polymers is, in number average molecular weight, in the range from 5,000 to 1,000,000, preferably from 10,000 to 200,000. Those having too small molecular weight exhibit insufficient mechanical strength on forming the image-forming layer, and those having too large molecular weight are also not preferred because the filming properties result poor. Further, crosslinking polymer latexes are particularly preferred for use. Specific examples of preferred polymer latexes include:

Latex of methyl methacrylate (70)-ethyl acrylate (27)-methacrylic acid (3).

Latex of methyl methacryl ate (70)-2-ethylhexyl acryl ate (20)-styrene (5)-acrylic acid (5).

Latex of styrene (50)-butadiene (47)-methacrylic acid (3).

Latex of styrene (68)-butadiene (29)-acrylic acid (3).

Latex of styrene (71)-butadiene (26)-acrylic acid (3).

Latex of styrene (70)-butadiene (27)-itaconic acid (3).

Latex of styrene (75)-butadiene (24)-acrylic acid (1).

Latex of styrene (60)-butadiene (35)-divinylbenzene (3)-methacrylic acid (2).

Latex of styrene (70)-butadiene (25)-divinylbenzene (2)-acrylic acid (3).

Latex of vinyl chloride (50)-methyl methacrylate (20)-ethyl acrylate (20)-acrylonitrile (5)-acrylic acid (5).

Latex of vinylidene chloride (85)-methyl methacrylate (5)-ethyl acrylate (5)-methacrylic acid (5).

Latex of ethylene (90)-methacrylic acid (10).

Latex of styrene (70)-2-ethylhexyl acrylate (27)-acrylic acid (3).

Latex of methyl methacrylate (63)-ethyl acrylate (35)-acrylic acid (2).

Latex of styrene (70.5)-butadiene (26.5)-acrylic acid (3).

Latex of styrene (69.5)-butadiene (27.5)-acrylic acid (3)

The numbers in parenthesis represent weight %. The polymer latexes above are commercially available. They may be used alone, or may be used by blending two or more types.

Styrene-butadiene copolymer are particularly preferable as the polymer latex for use as a binder. The weight ratio of monomer unit for styrene to that of butadiene constituting the styrene-butadiene copolymer is preferably in the range of from 40:60 to 95:5. Further, the monomer unit of styrene and that of butadiene preferably account for 60% by weight to 99% by weight with respect to the copolymer. Moreover, the polymer latex contains acrylic acid or methacrylic acid, preferably, in the range from 1% by weight to 6% by weight, and more preferably, from 2% by weight to 5% by weight, with respect to the total weight of the monomer unit of styrene and that of butadiene. The preferred range of the molecular weight is the same as that described above.

Preferred latexes include styrene (50)-butadiene (47)-methacrylic acid (3), styrene (60)-butadiene (35)-divinylbenzene-methyl methacrylate (3)-methacrylic acid (2), styrene (70.5)-butadiene (26.5)-acrylic acid (3) and commercially available LACSTAR-3307B, 7132C, and Nipol Lx4l6. Such latexes are described in U.S. Patent Application Publication 2005/0221237 (Sakai et al.) that is incorporated herein by reference.

Hardeners for various binders may be present if desired. Useful hardeners are well known and include diisocyanate compounds as described in EP 0 600 586 Bi (Philip, Jr. et al.), vinyl sulfone compounds as described in U.S. Pat. No. 6,143,487 (Philip, Jr. et al.) and EP 0 640 589 A1 (Gathmann et al.), aldehydes and various other hardeners as described in U.S. Pat. No. 6,190,822 (Dickerson et al.). The hydrophilic binders used in the thermally developable materials are generally partially or fully hardened using any conventional hardener. Useful hardeners are well known and are described, for example, in T. H. James, The Theory of the Photographic Process, Fourth Edition, Eastman Kodak Company, Rochester, N.Y., 1977, Chapter 2, pp. 77-8.

Where the proportions and activities of the thermally developable materials require a particular developing time and temperature, the binder(s) should be able to withstand those conditions. When a hydrophobic binder is used, it is preferred that the binder (or mixture thereof) does not decompose or lose its structural integrity at 120° C. for 60 seconds. When a hydrophilic binder is used, it is preferred that the binder does not decompose or lose its structural integrity at 150° C. for 60 seconds. It is more preferred that the binder not decompose or lose its structural integrity at 177° C. for 60 seconds.

The polymer binder(s) is used in an amount sufficient to carry the components dispersed therein. Preferably, a binder is used at a level of from about 10% to about 90% by weight (more preferably at a level of from about 20% to about 70% by weight) based on the total dry weight of the layer. It is particularly useful that the thermally developable materials include at least 50 weight % hydrophobic binders in both imaging and non-imaging layers on both sides of the support (and particularly the imaging side of the support).

### Support Materials

The thermally developable materials comprise a polymeric support that is preferably a flexible, transparent film that has any desired thickness and is composed of one or more polymeric materials. They are required to exhibit dimensional stability during thermal development and to have suitable adhesive properties with overlying layers. Useful polymeric materials for making such supports include polyesters [such as poly(ethylene terephthalate) and poly(ethylene naphthalate)], cellulose acetate and other cellulose esters, polyvinyl acetal, polyolefins, polycarbonates, and polystyrenes. Preferred supports are composed of polymers having good heat stability, such as polyesters and polycarbonates. Support materials may also be treated or annealed to reduce shrinkage and promote dimensional stability.

It is also useful to use transparent, multilayer, polymeric supports comprising numerous alternating layers of at least two different polymeric materials as described in U.S. Pat. No. 6,630,283 (Simpson et al.). Another support comprises dichroic mirror layers as described in U.S. Pat. No. 5,795,708 (Boutet). Both of the above patents are incorporated herein by reference.

Opaque supports can also be used, such as dyed polymeric films and resin-coated papers that are stable to high temperatures.

Support materials can contain various colorants, pigments, antihalation or acutance dyes if desired. For example, the support can include one or more dyes that provide a blue color in the resulting imaged film. Support materials may be treated using conventional procedures (such as corona discharge) to improve adhesion of overlying layers, or subbing or other adhesion-promoting layers can be used.

### Thermographic and Photothermographic Formulations and Constructions

An organic solvent-based coating formulation for the thermo-graphic and photothermographic emulsion layer(s) can be prepared by mixing the various components with one or more binders in a suitable organic solvent system that usually includes one or more solvents such as toluene, 2-butanone (methyl ethyl ketone), acetone, or tetrahydrofuran, or mixtures thereof. Methyl ethyl ketone is a preferred coating solvent.

Alternatively, the desired imaging components can be formulated with a hydrophilic binder (such as gelatin, or a gelatin-derivative), or a hydrophobic water-dispersible polymer latex (such as a styrene-butadiene latex) in water or water-organic solvent mixtures to provide aqueous-based coating formulations.

The thermally developable materials can contain plasticizers and lubricants such as poly(alcohols) and diols as described in U.S. Pat. No. 2,960,404 (Milton et al.), fatty acids or esters as described in U.S. Pat. No. 2,588,765 (Robijns) and U.S. Pat. No. 3,121,060 (Duane), and silicone resins as described in GB 955,061 (DuPont). The materials can also contain inorganic and organic matting agents as described in U.S. Pat. No. 2,992,101 (Jelley et al.) and U.S. Pat. No. 2,701,245 (Lynn). Polymeric fluorinated surfactants may also be useful in one or more layers as described in U.S. Pat. No. 5,468,603 (Kub).

The thermally developable materials may also include a surface protective layer over the one or more emulsion layers. Layers to reduce emissions from the material may also be present, including the polymeric barrier layers described in U.S. Pat. No. 6,352,819 (Kenney et al.), U.S. Pat. No. 6,352,820 (Bauer et al.), U.S. Pat. No. 6,420,102 (Bauer et al.), U.S. Pat. No. 6,667,148 (Rao et al.), and U.S. Pat. No. 6,746,831 (Hunt).

U.S. Pat. No. 6,436,616 (Geisler et al.), incorporated herein by reference, describes various means of modifying photothermographic materials to reduce what is known as the “woodgrain” effect, or uneven optical density.

To promote image sharpness, the photothermographic materials can contain one or more layers containing acutance and/or antihalation dyes. These dyes are chosen to have absorption close to the exposure wavelength and are designed to absorb scattered light. One or more antihalation compositions may be incorporated into the support, backside layers, underlayers, or overcoat layers. Additionally, one or more acutance dyes may be incorporated into one or more frontside imaging layers.

Dyes useful as antihalation and acutance dyes include squaraine dyes as described in U.S. Pat. No. 5,380,635 (Gomez et al.), and U.S. Pat. No. 6,063,560 (Suzuki et al.), and EP 1 083 459A1 (Kimura), indolenine dyes as described in EP 0 342 810A1 (Leichter), and cyanine dyes as described in U.S. Pat. No. 6,689,547 (Hunt et al.).

It may also be useful to employ compositions including acutance or antihalation dyes that will decolorize or bleach with heat during processing as described in U.S. Pat. No. 5,135,842 (Kitchin et al.), U.S. Pat. No. 5,266,452 (Kitchin et al.), U.S. Pat. No. 5,314,795 (Helland et al.), and U.S. Pat. No. 6,306,566, (Sakurada et al.), and Japan Kokai 2001-142175 (Hanyu et al.) and 2001-183770 (Hanyu et al.). Useful bleaching compositions are described in Japan Kokai 11-302550 (Fujiwara), 2001-109101 (Adachi), 2001-51371 (Yabuki et al.), and 2000-029168 (Noro).

Other useful heat-bleachable antihalation compositions can include an infrared radiation absorbing compound such as an oxonol dye or various other compounds used in combination with a hexaarylbiimidazole (also known as a “HABI”), or mixtures thereof. HABI compounds are described in U.S. Pat. No. 4,196,002 (Levinson et al.), U.S. Pat. No. 5,652,091 (Perry et al.), and U.S. Pat. No. 5,672,562 (Perry et al.). Examples of such heat-bleachable compositions are described for example in U.S. Pat. No. 6,455,210 (Irving et al.), U.S. Pat. No. 6,514,677 (Ramsden et al.), and U.S. Pat. No. 6,558,880 (Goswami et al.).

Under practical conditions of use, these compositions are heated to provide bleaching at a temperature of at least 90° C. for at least 0.5 seconds (preferably, at a temperature of from about 100° C. to about 200° C. for from about 5 to about 20 seconds).

Mottle and other surface anomalies can be reduced by incorporating a fluorinated polymer as described, for example, in U.S. Pat. No. 5,532,121 (Yonkoski et al.) or by using particular drying techniques as described, for example in U.S. Pat.5,621,983 (Ludemann et al.).

It is preferable for the photothermographic material to include one or more radiation absorbing substances that are generally incorporated into one or more photothermographic layer(s)to provide a total absorbance of all layers on that side of the support of at least 0.1 (preferably of at least 0.6) at the exposure wavelength of the photothermographic material. Where the imaging layers are on one side of the support only, it is also desired that the total absorbance at the exposure wavelength for all layers on the backside (non-imaging) side of the support be at least 0.2.

Thermographic and photothermographic formulations of can be coated by various coating procedures including wire wound rod coating, dip coating, air knife coating, curtain coating, slide coating, or extrusion coating using hoppers of the type described in U.S. Pat. No. 2,681,294 (Beguin). Layers can be coated one at a time, or two or more layers can be coated simultaneously by the procedures described in U.S. Pat. No. 2,761,791 (Russell), U.S. Pat. No. 4,001,024 (Dittman et al.), U.S. Pat. No. 4,569,863 (Keopke et al.), U.S. Pat. No. 5,340,613 (Hanzalik et al.), U.S. Pat. No. 5,405,740 (LaBelle), U.S. Pat. No. 5,415,993 (Hanzalik et al.), U.S. Pat. No. 5,525,376 (Leonard), U.S. Pat. No. 5,733,608 (Kessel et al.), U.S. Pat. No. 5,849,363 (Yapel et al.), U.S. Pat. No. 5,843,530 (Jerry et al.), and U.S. Pat. No. 5,861,195 (Bhave et al.), and GB 837,095 (Ilford). A typical coating gap for the emulsion layer can be from about 10 to about 750 μm, and the layer can be dried in forced air at a temperature of from about 20° C. to about 100° C. It is preferred that the thickness of the layer be selected to provide maximum image densities greater than about 0.2, and more preferably, from about 0.5 to 5.0 or more, as measured by an X-rite Model 361/V Densitometer equipped with 301 Visual Optics, available from X-rite Corporation, (Granville, Mich.).

Preferably, two or more layer formulations are simultaneously applied to a support using slide coating, the first layer being coated on top of the second layer while the second layer is still wet. The first and second fluids used to coat these layers can be the same or different solvents. For example, subsequently to, or simultaneously with, application of the emulsion formulation(s) to the support, a protective overcoat formulation can be applied over the emulsion formulation. Simultaneous coating can be used to apply layers on the frontside, backside, or both sides of the support.

In other embodiments, a “carrier” layer formulation comprising a single-phase mixture of two or more polymers described above may be applied directly onto the support and thereby located underneath the emulsion layer(s) as described in U.S. Pat. No. 6,355,405 (Ludemann et al.). The carrier layer formulation can be simultaneously applied with application of the emulsion layer formulation(s) and any overcoat or surface protective layers.

The thermally developable materials can include one or more antistatic or conductive layers agents in any of the layers on either or both sides of the support. Conductive components include soluble salts, evaporated metal layers, or ionic polymers as described in U.S. Pat. No. 2,861,056 (Minsk) and U.S. Pat. No. 3,206,312 (Sterman et al.), insoluble inorganic salts as described in U.S. Pat. No. 3,428,451 (Trevoy), electroconductive underlayers as described in U.S. Pat. No. 5,310,640 (Markin et al.), electronically-conductive metal antimonate particles as described in U.S. Pat. No. 5,368,995 (Christian et al.), and electrically-conductive metal-containing particles dispersed in a polymeric binder as described in EP 0 678 776 Al (Melpolder et al.). Particularly useful conductive particles are the non-acicular metal antimonate particles used in a buried backside conductive layer as described and in U.S. Pat. No. 6,689,546 (LaBelle et al.), U.S. Pat. No. 7,018,787 (Ludemann et al.), and U.S. Pat. 7,022,467 (Ludemann et al.) and in U.S. Patent Application Publications 2006/0046215 (Ludemann et al.), 2006/0046932, and 2006/0093973 (Ludemann et al.).

It is particularly useful that the conductive layers be disposed on the backside of the support and especially where they are buried or underneath one or more other layers such as backside protective layer(s). Such backside conductive layers typically have a resistivity of about 10⁵ to about 10¹² ohm/sq as measured using a salt bridge water electrode resistivity measurement technique. This technique is described in R. A. Elder Resistivity Measurements on Buried Conductive Layers, EOS/ESD Symposium Proceedings, Lake Buena Vista, Fla., 1990, pp. 251-254, incorporated herein by reference. [EOS/ESD stands for Electrical Overstress/Electrostatic Discharge].

Still other conductive compositions include one or more fluoro-chemicals each of which is a reaction product of R_{f}—CH₂CH₂—SO₃H with an amine wherein R_{f} comprises 4 or more fully fluorinated carbon atoms as described in U.S. Pat. No. 6,699,648 (Sakizadeh et al.). Additional conductive compositions include one or more fluorochemicals described in more detail in U.S. Pat. No. 6,762,013 (Sakizadeh et al.).

The thermally developable materials may also usefully include a magnetic recording material as described in Research Disclosure, Item 34390, November 1992, or a transparent magnetic recording layer such as a layer containing magnetic particles on the underside of a transparent support as described in U.S. Pat. No. 4,302,523 (Audran et al.).

While the carrier and emulsion layers can be coated on one side of the film support, manufacturing methods can also include forming on the opposing or backside of the polymeric support, one or more additional layers, including a conductive layer, antihalation layer, or a layer containing a matting agent (such as silica), or a combination of such layers. Alternatively, one backside layer can perform all of the desired functions.

In a preferred construction, a conductive “carrier” layer formulation comprising a single-phase mixture of two or more polymers and non-acicular metal antimonate particles, may be applied directly onto the backside of the support and thereby be located underneath other backside layers. The carrier layer formulation can be simultaneously applied with application of these other backside layer formulations.

Layers to promote adhesion of one layer to another are also known, such as those described in U.S. Pat. No. 5,891,610 (Bauer et al.), U.S. Pat. No. 5,804,365 (Bauer et al.), and U.S. Pat. No. 4,741,992 (Przezdziecki). Adhesion can also be promoted using specific polymeric adhesive materials as described in U.S. Pat. No. 5,928,857 (Geisler et al.).

It is also contemplated that the photothermographic materials include one or more photothermographic layers on both sides of the support and/or an antihalation underlayer beneath at least one photothermographic layer on at least one side of the support. In addition, the materials can have an outermost protective layer disposed over all photothermographic layers on both sides of the support.

### Imaging/Development

The thermally developable materials can be imaged in any suitable manner consistent with the type of material, using any suitable imaging source to which they are sensitive (typically some type of radiation or electronic signal for photothermographic materials and a source of thermal energy for thermographic materials). In most embodiments, the materials are sensitive to radiation in the range of from about at least 100 nm to about 1400 nm. In some embodiments, they materials are sensitive to radiation in the range of from about 300 nm to about 600 nm, more preferably from about 300 to about 450 nm, even more preferably from a wavelength of from about 360 to 420 nm. In preferred embodiments the materials are sensitized to radiation from about 600 to about 1200 nm and more preferably to infrared radiation from about 700 to about 950 nm. If necessary, sensitivity to a particular wavelength can be achieved by using appropriate spectral sensitizing dyes.

Imaging can be carried out by exposing the photothermographic materials to a suitable source of radiation to which they are sensitive, including X-radiation, ultraviolet radiation, visible light, near infrared radiation, and infrared radiation to provide a latent image. Suitable exposure means are well known and include phosphor emitted radiation (particularly X-ray induced phosphor emitted radiation), incandescent or fluorescent lamps, xenon flash lamps, lasers, laser diodes, light emitting diodes, infrared lasers, infrared laser diodes, infrared light-emitting diodes, infrared lamps, or any other ultraviolet, visible, or infrared radiation source readily apparent to one skilled in the art such as described in Research Disclosure, item 38957 (noted above). Particularly useful infrared exposure means include laser diodes emitting at from about 700 to about 950 nm, including laser diodes that are modulated to increase imaging efficiency using what is known as multi-longitudinal exposure techniques as described in U.S. Pat. No. 5,780,207 (Mohapatra et al.). Other exposure techniques are described in U.S. Pat. No. 5,493,327 (McCallum et al.).

The photothermographic materials also can be indirectly imaged using an X-radiation imaging source and one or more prompt-emitting or storage X-radiation sensitive phosphor screens adjacent to the photothermographic material. The phosphors emit suitable radiation to expose the photothermographic material. Preferred X-ray screens are those having phosphors emitting in the near ultraviolet region of the spectrum (from 300 to 400 nm), in the blue region of the spectrum (from 400 to 500 nm), and in the green region of the spectrum (from 500 to 600 nm).

In other embodiments, the photothermographic materials can be imaged directly using an X-radiation imaging source to provide a latent image.

Thermal development conditions will vary, depending on the construction used but will typically involve heating the imagewise exposed photo-thermographic material at a suitably elevated temperature, for example, at from about 50° C. to about 250° C. (preferably from about 80° C. to about 200° C. and more preferably from about 100° C. to about 200° C.) for a sufficient period of time, generally from about 1 to about 120 seconds. Heating can be accomplished using any suitable heating means such as contacting the material with a heated drum, plates, or rollers, or by providing a heating resistance layer on the rear surface of the material and supplying electric current to the layer so as to heat the material. A preferred heat development procedure for photothermographic materials includes heating within a temperature range of from 110 to 150° C for 25 seconds or less, for example, at least 3 and up to 25 seconds (and preferably for 20 seconds or less) to develop the latent image into a visible image having a maximum density (Dₘₐₓ) of at least 3.0. Line speeds during development of greater than 61 cm/min, such as from 61 to 200 cm/min can be used.

When imaging direct thermographic materials, the image may be “written” simultaneously with development at a suitable temperature using a thermal stylus, a thermal print-head or a laser, or by heating while in contact with a heat-absorbing material. The thermographic materials may include a dye (such as an IR-absorbing dye) to facilitate direct development by exposure to laser radiation.

Thermal development of either thermographic or photothermo-graphic materials is carried out with the material being in a substantially water-free environment and without application of any solvent to the material.

### Use as a Photomask

The thermographic and photothermographic materials can be sufficiently transmissive in the range of from about 350 to about 450 nm in non-imaged areas to allow their use in a method where there is a subsequent exposure of an ultraviolet or short wavelength visible radiation sensitive imageable medium. The thermally-developed materials absorb ultraviolet or short wavelength visible radiation in the areas where there is a visible image and transmit ultraviolet or short wavelength visible radiation where there is no visible image. The thermally-developed materials may then be used as a mask and positioned between a source of imaging radiation (such as an ultraviolet or short wavelength visible radiation energy source) and an imageable material that is sensitive to such imaging radiation, such as a photopolymer, diazo material, photoresist, or photosensitive printing plate. Exposing the imageable material to the imaging radiation through the visible image in the exposed and heat-developed thermographic or photothermographic material provides an image in the imageable material. This method is particularly useful where the imageable medium comprises a printing plate and the thermally developable material serves as an image-setting film.

Thus, in some other embodiments wherein the thermographic or photothermographic material comprises a transparent support, the image-forming method further comprises, after steps (A) and (B) or step (A′) noted above:

(C) positioning the exposed and heat-developed photothermographic material between a source of imaging radiation and an imageable material that is sensitive to the imaging radiation, and

(D) exposing the imageable material to the imaging radiation through the visible image in the exposed and heat-developed photothermographic material to provide an image in the imageable material.

The following examples are provided to illustrate the practice of the present invention and the invention is not meant to be limited thereby.

### Materials and Methods for the Examples:

All materials used in the following examples are readily available from standard commercial sources, such as Aldrich Chemical Co. (Milwaukee Wis.) unless otherwise specified. All percentages are by weight unless otherwise indicated. The following additional terms and materials were used.

Many of the chemical components used herein are provided as a solution. The term “active ingredient” means the amount or the percentage of the desired chemical component contained in a sample. All amounts listed herein are the amount of active ingredient added unless otherwise specified.

PARALOID® A-2 1 is an acrylic copolymer available from Rohm and Haas (Philadelphia, Pa.).

BZT is benzotriazole.

CAB 171-15S is a cellulose acetate butyrate resin available from Eastman Chemical Co (Kingsport, Tenn.).

DESMODUR® N3300 is a trimer of an aliphatic hexamethylene diisocyanate available from Bayer Chemicals (Pittsburgh, Pa.).

PIOLOFORM® BL-16 is reported to be a polyvinyl butyral resin having a glass transition temperature of about 84° C. PIOLOFORM® BM- 18 is reported to be a polyvinyl butyral resin having glass transition temperature of about 70° C. Both are available from Wacker Polymer Systems (Adrian, Mich.).

MEK is methyl ethyl ketone (or 2-butanone).

Vinyl Sulfone-1 (VS-1) is described in U.S. Pat. No. 6,143,487 and has the structure shown below.

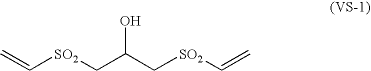

Antifoggant AF-A is 2-pyridyltribromomethylsulfone and has the structure shown below.

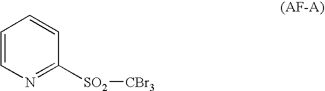

Antifoggant AF-B is ethyl-2-cyano-3-oxobutanoate. It is described in U.S. Pat. No. 5,686,228 (Murray et al.) and has the structure shown below.

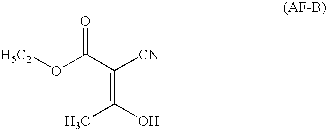

Acutance Dye AD-I has the following structure:

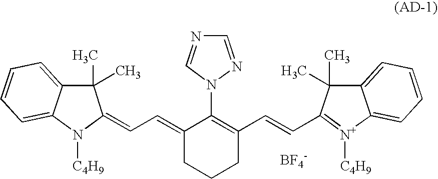

Sensitizing Dye A is described in U.S. Pat. No. 5,541,054 (Miller et al.) has the structure shown below.

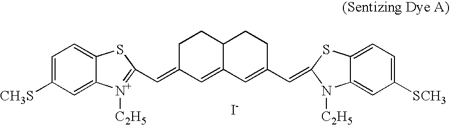

Tinting Dye TD-1 has the following structure:

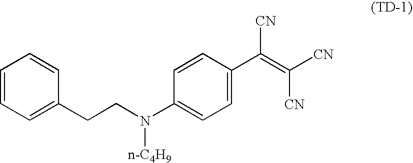

Support Dye SD-1 has the following structure:

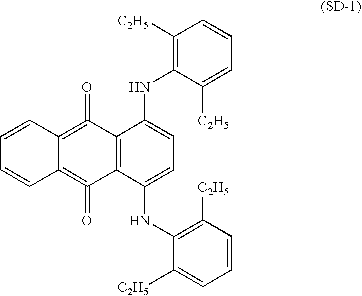

Comparative Compound 1 (CC-1) has the following structure

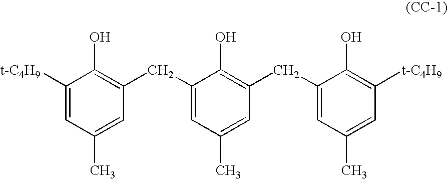

### EXAMPLE 1

The following example demonstrates the improvement in hot-dark print stability using a combination of trisphenol and bisphenol reducing agents.

Preparation of Photothermographic Emulsion Formulation:

A preformed silver halide, silver carboxylate soap dispersion, was prepared in similar fashion to that described in U.S. Pat. No. 5,939,249 (noted above). The core-shell silver halide emulsion had a silver iodobromide core with 8% iodide, and a silver bromide shell doped with iridium and copper. The core made up 25% of each silver halide grain, and the shell made up the remaining 75%. The silver halide grains were cubic in shape, and had a mean grain size between 0.055 and 0.06 μm. The preformed silver halide, silver carboxylate soap dispersion was made by mixing 26.1% preformed silver halide, silver carboxylate soap, 2.1% PIOLOFORM® BM-18 polyvinyl butyral binder, and 71.8% MEK, and homogenizing three times at 8000 psi (55 MPa).

A photothermographic emulsion formulation was prepared at 67° F. (19.4° C.) containing 174 parts of the above preformed silver halide at 28.2% solids, silver carboxylate soap dispersion. To this formulation was added 1.6 parts of a 15% solution of pyridinium hydrobromide perbromide in methanol, with stirring. After 45 minutes of mixing, 2.1 parts of an 11% zinc bromide solution in methanol was added. Stirring was continued and after 30 minutes, a solution of 0.15 parts 2-mercapto-5-methylbenzimidazole, 0.007 parts of Sensitizing Dye A, 1.7 parts of 2-(4-chlorobenzoyl)benzoic acid, 10.8 parts of methanol, and 3.8 parts of MEK were added. After stirring for 75 minutes, the temperature was lowered to 50° F. (10° C.), and 26.15 parts of PIOLOFORM® BM-18 and 19.8 parts of PIOLOFORM® BL-16 were added. Mixing was continued for another 15 minutes.

The emulsion formulation was completed by adding the materials shown below. Five minutes were allowed between the additions of each component.

| Solution A containing: | | |
|---|---|---|
| Antifoggant AF-A | 0.80 | parts |
| Tetrachlorophthalic acid (TCPA) | 0.37 | parts |
| 4-Methylphthalic acid (4-MPA) | 0.71 | parts |
| MEK | 21 | parts |
| Methanol | 0.36 | parts |
| Solution B containing: | | |
| DESMODUR ® N3300 Solution | 0.66 | parts in |
| | 0.33 | parts MEK |
| Solution C containing: | | |
| Phthalazine (PHZ) Solution | 1.3 | parts in |
| | 6.3 | parts MEK |

To 25.5 parts of the completed emulsion formulation was added the amount of reducing agent or reducing agent mixture shown in TABLE IV, and enough additional MEK for the emulsion to contain 37.1% solids.

Overcoat Formulation-A:

Overcoat Formulation-A was prepared by mixing the following materials:

| | | |
|---|---|---|
| MEK | 329.04 | parts |
| PARALOID ® A-21 | 2.34 | parts |
| CAB 171-15S | 25.57 | parts |
| Vinyl Sulfone VS-1 | 1.18 | parts, 82.89% |
| | | active (0.98 parts net) |
| Benzotriazole (BZT) | 0.72 | parts |
| Acutance Dye AD-1 | 0.48 | parts |
| Antifoggant AF-B | 0.64 | parts |
| DESMODUR ® N3300 Solution | 1.92 | parts, in |
| | 0.94 | parts MEK |
| Tinting Dye TD-1 | 0.016 | parts |

Overcoat Formulation-B:

Overcoat Formulation-B was prepared by mixing the following materials:

| | | |
|---|---|---|
| MEK | 329.04 | parts |
| PARALOID ® A-21 | 2.34 | parts |
| CAB 171-15S | 25.57 | parts |
| Vinyl Sulfone VS-1 | 1.18 | parts, 82.89% |
| | | active (0.98 parts net) |
| Benzotriazole (BZT) | 0.72 | parts |
| Acutance Dye AD-1 | 0.29 | parts |
| Antifoggant AF-B | 0.64 | parts |
| DESMODUR ® N3300 Solution | 1.92 | parts, in |
| | 0.94 | parts MEK |
| Tinting Dye TD-1 | 0.021 | parts |

Preparation of Photothermographic Materials:

The photothermographic emulsion and overcoat formulations were simultaneously coated onto a 7 mil (178 μm) polyethylene terephthalate support, tinted blue with support dye SD-1. An automated dual knife coater equipped with an in-line dryer was used. Immediately after coating, samples were dried in a forced air oven at between 90 and 97° C. for between 4 and 7 minutes. The photo-thermographic emulsion formulation was coated to obtain a coating weight of between about 1.65 and 2.00 g of total silver/m². The overcoat formulation was coated to obtain about a dry coating weight of about 0.2 g/ft² (2.2 g/m²) and an absorbance in the imaging layer of between 0.9 and 1.35 at 810 μm.

The backside of the support had been coated with an antihalation and antistatic layer having an absorbance greater than 0.3 between 805 and 815 nm, and a resistivity of less than 10¹¹ ohms/square.

Samples of each photothermographic material were cut into strips, exposed with a laser sensitometer at 810 nm, and thermally developed to generate continuous tone wedges with image densities varying from a minimum density (Dₘᵢₙ) to a maximum density (Dₘₐₓ) possible for the exposure source and development conditions. Development was carried out on a 6 inch diameter (15.2 cm) heated rotating drum. The strip contacted the drum for 210 degrees of its revolution, about 11 inches (28 cm). Samples were developed at 122.5° C. for 15 seconds at a rate of 0.733 inches/sec (112 cm/min) A strip sample of each photothermographic material was scanned using a computerized densitometer equipped with both a visible filter and a blue filter having peak transmission at about 440 nm. The Dₘᵢₙ, Dₘₐₓ, Silver Efficiency (Dₘₐₓ/Silver Coating Weight in g/m²), AC-1, Speed-2, and hot-dark print stability were measured using the blue filter. The data, shown below in TABLE IV, demonstrate that the reducing agent combinations to provide improved Silver Efficiency.

Calculation of Silver Efficiency:

Silver efficiency was calculated for each sample by dividing Dₘₐₓ by silver coating weight in g/m². The silver coating weight of each film sample was measured by X-ray fluorescence using commonly known techniques.

Evaluation of Hot-Dark Print Stability:

A continuous tone wedge strip sample of each developed photo-thermographic coating prepared above, was illuminated with fluorescent lighting for 3 hours at 70° F. (21° C.) and 50% relative humidity. The illumination at the surface of each strip sample was 90 to 120 foot candles (968 to 1291 lux). Each sample was then re-scanned using the same computer densitometer and using the blue filter having a peak transmittance at about 440 nm. The D_{min-Blue}, D_{max-Blue}, and the point on the strip having an optical density of approximately 1.2 (OD-Blue) were recorded.

A set of processed samples was then stacked together and tightly double-bagged in two high-density, flat-black polyethylene bags. Three strips of polyethylene terephthalate support tinted blue with support dye SD-1 were placed above and below the stack of film samples. The bagged samples were then placed in an oven and heated at 68-74° C. for 3 hours. Upon cooling to room temperature, the samples were removed from the bag and re-scanned using the same densitometer and blue filter. The changes in D_{min-Blue} (ΔD_{min-Blue}), D_{max-Blue}, (ΔD_{max-Blue}), and OD-Blue (ΔOD-Blue) were recorded to determine the hot-dark print stability.

The results, shown below in TABLE V demonstrate the unique ability of reducing agent combinations to provide improved hot-dark print stability.

TABLE IV

| | | | | Silver Efficiency | | | | | |
|---|---|---|---|---|---|---|---|---|---|
| | Reducing | Amount | | (Dmax/Ag | Absorbance | Initial | Initial | | |
| Sample | Agent | (parts) | Overcoat | Coating Wt.) | 810 nm | Dmin | Dmax | Speed-2 | AC-1 |
| 1-1-Comparative | III-7 | 0.89 | A | 1.93 | 1.05 | 0.216 | 3.73 | 1.69 | 3.59 |
| 1-2-Inventive | I-2 + III-4 | 0.45 | A | 2.05 | 0.93 | 0.217 | 3.91 | 1.76 | 3.87 |
| | | 0.25 | | | | | | | |

TABLE V

| | ΔDmin-Blue | ΔOD-Blue at | ΔDmax-Blue |
|---|---|---|---|
| | After 3 Hours | 1.2 After 3 Hours | After 3 Hours |
| | Hot-Dark | Hot-Dark | Hot-Dark |
| Sample | Print Stability | Print Stability | Print Stability |
| 1-1-Comparative | 0.057 | 0.708 | 0.71 |
| 1-2-Inventive | 0.045 | 0.246 | 0.25 |

### EXAMPLE 2

Photothermographic materials were prepared, coated, imaged, and evaluated for hot-dark print stability substantially as described in Example 1 but incorporating combinations of trisphenol and monophenol reducing agents.

The results, shown below in TABLES VI and VII demonstrate the unique ability of reducing agent combinations to provide improved silver efficiency and hot-dark print stability.

TABLE VI

| | Reducing | Amount | | Absorbance | Initial | Initial | Silver Efficiency | | |
|---|---|---|---|---|---|---|---|---|---|
| Sample | Agent | (parts) | Overcoat | 810 nm | Dmin | Dmax | (Dmax/Ag Ct. Wt.) | Speed-2 | AC-1 |
| 2-1-Comparative | III-7 | 0.89 | A | 1.10 | 0.213 | 3.85 | 1.96 | 1.72 | 3.67 |
| 2-2-Inventive | I-2 + II-8 | 0.60 | B | 1.19 | 0.212 | 3.85 | 2.16 | 1.73 | 3.92 |
| | | 0.70 | | | | | | | |
| 2-3-Inventive | I-3 + II-8 | 0.81 | B | 1.19 | 0.213 | 3.94 | 2.21 | 1.70 | 4.00 |
| | | 0.70 | | | | | | | |
| 2-4-Inventive | I-3 + II-8 | 0.81 | A | 0.95 | 0.210 | 3.93 | 2.23 | 1.74 | 4.71 |
| | | 0.70 | | | | | | | |
| 2-5-Inventive | I-1 + II-8 | 0.73 | B | 1.19 | 0.213 | 3.71 | 2.07 | 1.50 | 3.23 |
| | | 0.70 | | | | | | | |
| 2-6-Inventive | I-1 + II-8 | 0.73 | A | 0.95 | 0.209 | 3.68 | 2.13 | 1.56 | 3.63 |
| | | 0.70 | | | | | | | |

TABLE VII

| | ΔDmin-Blue | ΔOD-Blue at | ΔDmax-Blue |
|---|---|---|---|
| | After 3 Hours | 1.2 After 3 Hours | After 3 Hours |
| | Hot-Dark | Hot-Dark | Hot-Dark |
| Sample | Print Stability | Print Stability | Print Stability |
| 2-1-Comparative | 0.036 | 0.466 | 0.47 |
| 2-2-Inventive | 0.015 | 0.133 | 0.16 |
| 2-3-Inventive | 0.010 | 0.089 | 0.15 |
| 2-4-Inventive | 0.011 | 0.073 | 0.16 |
| 2-5-Inventive | 0.011 | 0.045 | 0.17 |
| 2-6-Inventive | 0.010 | 0.023 | 0.12 |

### EXAMPLE 3

Photothermographic materials were prepared, coated, imaged, and evaluated for hot-dark print stability substantially as described in Example 1. Comparative Sample 3-1 contained only a bisphenol reducing agent, Comparative Samples 3-2 and 3-3 contained a mixture of a bisphenol and a monophenol reducing agent. Inventive Samples 3-4 and 3-5 contained a mixture of a trisphenol and monophenol reducing agent.

The results, shown below in TABLES VIII and IX demonstrate the unique ability of reducing agent combinations comprising a trisphenol to provide improved hot-dark print stability. Inventive Samples 3-4 and 3-5 showed higher Silver Efficiency and less change in D_{min-Blue}, D_{max-Blue}, and Density at 1.2 OD-Blue than comparative samples not containing a trisphenol developer.

TABLE VIII

| | Reducing | Amount | | Absorbance | Initial | Initial | Silver Efficiency | | |
|---|---|---|---|---|---|---|---|---|---|
| Sample | Agent | (parts) | Overcoat | 810 nm | Dmin | Dmax | (Dmax/Ag Ct. Wt.) | Speed-2 | AC-1 |
| 3-1-Comparative | III-7 | 0.89 | A | 1.04 | 0.225 | 3.74 | 1.95 | 1.73 | 3.57 |
| 3-2-Comparative | III-7 + II-8 | 0.71 | A | 0.98 | 0.215 | 3.78 | 1.96 | 1.67 | 3.87 |
| | | 0.35 | | | | | | | |
| 3-3-Comparative | III-7 + II-8 | 0.71 | A | 1.03 | 0.216 | 3.60 | 1.92 | 1.64 | 3.73 |
| | | 0.70 | | | | | | | |
| 3-4-Inventive | I-2 + II-8 | 0.60 | A | 0.99 | 0.216 | 3.68 | 2.07 | 1.71 | 3.90 |
| | | 0.35 | | | | | | | |
| 3-5-Inventive | I-2 + II-8 | 0.60 | A | 0.94 | 0.219 | 3.76 | 2.12 | 1.70 | 3.99 |
| | | 0.70 | | | | | | | |

TABLE IX

| | ΔDmin-Blue | ΔOD-Blue | ΔDmax-Blue |
|---|---|---|---|
| | After 3 Hours | at 1.2 After 3 Hours | After 3 Hours |
| | Hot-Dark | Hot-Dark | Hot-Dark |
| Sample | Print Stability | Print Stability | Print Stability |
| 3-1-Comparative | 0.025 | 0.309 | 0.33 |
| 3-2-Comparative | 0.025 | 0.460 | 0.51 |
| 3-3-Comparative | 0.029 | 0.495 | 0.61 |
| 3-4-Inventive | 0.012 | 0.158 | 0.22 |
| 3-5-Inventive | 0.016 | 0.145 | 0.28 |

### EXAMPLE 4

Photothermographic materials were prepared, coated, imaged, and evaluated for hot-dark print stability substantially as described in Example 1. Comparative Sample 4-1 contained only a bisphenol reducing agent, Inventive Samples 4-2 and 4-3 contained a mixture of a trisphenol and monophenol reducing agent. In Comparative Sample 4-1, the reducing agent composition was added to 25.5 parts of the emulsion formulation. In Inventive Samples 4-2 and 4-3, the reducing agent composition was added to the full emulsion formulation The results, shown below in TABLES X and XI demonstrate the unique ability of reducing agent combinations comprising a trisphenol to provide improved Silver Efficiency, Image Tone, and hot-dark print stability. Inventive Samples 4-2 and 4-3 showed higher Silver Efficiency and less change in D_{min-Blue}, D_{max-Blue}, and Density at 1.2 OD-Blue than the Comparative Sample. Image tone, measured at a visible density of 2.0, is the difference of the blue filter density from 2.0. The larger Image Tone values for the Inventive Samples 4-2 and 4-3 indicate a bluer image than the Comparative Sample.

TABLE X

| | | | | | | | Silver | | | |
|---|---|---|---|---|---|---|---|---|---|---|
| | | | | | | | Efficiency | Image | | |
| | Reducing | Amount | | Absorbance | Initial | Initial | (Dmax/Ag Ct. | Tone | | |
| Sample | Agent | (parts) | Overcoat | 810 nm | Dmin | Dmax | Wt.) | at D = 2.0 | Speed-2 | AC-1 |
| 4-1-Comparative | III-7 | 0.89 | A | 1.01 | 0.218 | 3.83 | 1.96 | 0.190 | 1.76 | 3.81 |
| 4-2-Inventive | I-2 + II-8 | 6.34 | A | 0.96 | 0.218 | 3.89 | 2.19 | 0.248 | 1.82 | 4.22 |
| | | 7.48 | | | | | | | | |
| 4-3-Inventive | I-2 + II-8 | 6.34 | B | 1.17 | 0.220 | 3.91 | 2.15 | 0.232 | 1.78 | 3.93 |
| | | 7.48 | | | | | | | | |

TABLE XI

| | ΔDmin-Blue | ΔOD-Blue | ΔDmax-Blue |
|---|---|---|---|
| | After 3 Hours | at 1.2 After 3 Hours | After 3 Hours |
| | Hot-Dark | Hot-Dark | Hot-Dark |
| Sample | Print Stability | Print Stability | Print Stability |
| 4-1-Comparative | 0.028 | 0.330 | 0.35 |
| 4-2-Inventive | 0.015 | 0.092 | 0.17 |
| 4-3-Inventive | 0.012 | 0.064 | 0.13 |

### EXAMPLE 5

Preparation of Photothermographic Emulsion Formulation:

A preformed silver halide, silver carboxylate soap dispersion, was prepared in similar fashion to that described in U.S. Pat. No. 5,939,249 (noted above) and as described in Example 1.

A photothermographic emulsion formulation was prepared at 67° F. (19.4° C.) containing 174 parts of the above preformed silver halide, silver carboxylate soap dispersion and 4.6 parts of MEK. To this formulation was added 1.6 parts of a 15% solution of pyridinium hydrobromide perbromide in methanol, with stirring. After 45 minutes of mixing, 2.1 parts of an 11% zinc bromide solution in methanol was added. Stirring was continued and after 30 minutes, a solution of 0.18 parts 2-mercapto-5-methylbenzimidazole, 0.009 parts of Sensitizing Dye A, 2.0 parts of 2-(4-chlorobenzoyl)benzoic acid, 10.8 parts of methanol, and 3.4 parts of MEK were added. After stirring for 75 minutes, the temperature was lowered to 50° F. (10° C.), and 46.16 parts of PIOLOFORM® BL-16 were added. Mixing was continued for another 15 minutes.

Reducing agent or reducing agent mixtures were added to separately prepared photothermographic emulsion formulations. Mixing was continued for another 5 minutes.

TABLE XII

| Sample | Reducing Agent(s) | Amount |
|---|---|---|
| 5-1 Comparative | Compound I-2 | 4.21 g |
| 5-2 Inventive | Compound I-2 and | 4.21 g |
| | Compound II-9 | 9.48 g |
| 5-3 Inventive | Compound I-2 and | 4.21 g |
| | Compound II-17 | 6.71 g |
| 5-4 Inventive | Compound I-2 and | 4.21 g |
| | Compound II-8 | 7.54 g |

The emulsion formulation was completed by adding the materials shown below. Five minutes were allowed between the additions of each component.

| Solution A containing: | | |
|---|---|---|
| Antifoggant AF-A | 0.80 | parts |
| Tetrachlorophthalic acid (TCPA) | 0.37 | parts |
| 4-Methylphthalic acid (4-MPA) | 0.71 | parts |
| MEK | 21 | parts |
| Methanol | 0.36 | parts |
| Solution B containing: | | |
| DESMODUR ® N3300 Solution | 0.66 | parts in |
| | 0.33 | parts MEK |
| Solution C containing: | | |
| Phthalazine (PHZ) | 1.4 | parts in |
| | 6.3 | parts MEK |

Overcoat Formulation-C:

Overcoat Formulation-C was prepared by mixing the following materials:

| | | |
|---|---|---|
| MEK | 458.1 | parts |
| PARALOID ® A-21 | 2.93 | parts |
| CAB 171-15S | 31.95 | parts |
| Vinyl Sulfone VS-1 | 1.62 | parts, 80.8% |
| | | active (0.1.30 parts |
| | | net) |
| Benzotriazole (BZT) | 0.91 | parts |
| Acutance Dye AD-1 | 0.91 | parts |
| Antifoggant AF-B | 0.8 | parts |
| DESMODUR ® N3300 Solution | 2.4 | parts, in |
| | 0.76 | parts MEK |
| Tinting Dye TD-1 | 0.022 | parts |

Preparation of Photothermographic Materials:

Sample 5-1 contained only a trisphenol reducing agent. It served as a control. Samples 5-2, 5-3 and 5-4 contained a mixture of reducing agents.

The photothermographic emulsion and overcoat formulations were simultaneously coated onto a 7 mil (178 μm) polyethylene terephthalate support, tinted blue with support dye SD-1. An automated dual knife coater equipped with an in-line dryer was used. Immediately after coating, samples were dried in a forced air oven at between 90 and 97° C. for between 4 and 6 minutes. The photo-thermographic emulsion formulation was coated to obtain a coating weight of between about 1.6 and 2.0 g of total silver/m². The overcoat formulation was coated to obtain a dry coating weight of about 0.2 g/ft² (2.2 g/m²) and an absorbance in the imaging layer between 0.9 and 1.0 at 815 nm.

The backside of the support had been coated with an antihalation and antistatic layer having an absorbance greater than 0.3 between 805 and 815 nm, and a resistivity of less than 10¹¹ ohms/square.

Samples of each photothermographic material were cut into strips and imaged with a laser sensitometer at 810 nm, and thermally developed as described in Example 1.

A strip sample of each photothermographic material was scanned using a computerized densitometer equipped with both a visible filter and a blue filter having peak transmission at about 440 nm as described in Example 1. TABLE XIII shows the values for Dₘᵢₙ, Dₘₐₓ, Speed-2, and. Silver Efficiency for these samples using a visual filter.

The results, shown below in Table XIII, demonstrate that the mixtures of a trisphenol reducing agent with a monophenol reducing agent provide improved Silver Efficiency when compared to the use of a trisphenol reducing agent alone.

TABLE XIII

| | | | | Silver Coating Wt. | Silver Efficiency |
|---|---|---|---|---|---|
| Sample | Dmin | Dmax | Speed-2 | (g/m²) | (Dmax/Ag Ct. Wt.) |
| 5-1 Comparative | 0.221 | 2.620 | 1.726 | 1.87 | 1.40 |
| 5-2 Inventive | 0.217 | 3.411 | 1.861 | 1.69 | 2.02 |
| 5-3 Inventive | 0.216 | 3.738 | 1.744 | 1.77 | 2.11 |
| 5-4 Inventive | 0.221 | 3.978 | 1.782 | 1.80 | 2.21 |

### EXAMPLE 6

Photothermographic materials were prepared in the same manner as described in Example 5 using the amounts of reducing agents shown below in TABLE XIV.

TABLE XIV

| Sample | Reducing Agent(s) | Amount | |
|---|---|---|---|
| 6-1 Comparative | Compound III-7 | 9.52 | g |
| 6-2-Inventive | Compound I-3 | 5.75 | g |
| | Compound II-8 | 6.5 | g |
| 6-3-Comparative | Compound CC-1 | 5.16 | |
| | Compound II-8 | 6.5 | g |

Samples were coated, dried, imaged, and evaluated as described in Example 1. TABLE XV shows the sensitometric values for Dₘᵢₙ, Dₘₐₓ, Speed-2, and Silver Efficiency for each sample using a visual filter. The data demonstrate that Inventive Sample 6-2 has a higher Silver Efficiency than Comparative Sample 6-1. Although Comparative Sample 6-3 showed high Silver Efficiency, it also has unacceptably high Dₘᵢₙ.

TABLE XV

| | | | | Silver Coating Wt. | Silver Efficiency |
|---|---|---|---|---|---|
| Sample | Dmin | Dmax | Speed-2 | (g/m²) | (Dmax/Ag Ct. Wt.) |
| 6-1 Comparative | 0.218 | 3.402 | 1.758 | 1.62 | 2.1 |
| 6-2 Inventive | 0.212 | 3.674 | 1.675 | 1.65 | 2.23 |
| 6-3 Comparative | 0.287 | 3.748 | 2.007 | 1.71 | 2.19 |

### EXAMPLE 7

Preparation of Photothermographic Emulsion Formulation:

A preformed silver halide, silver carboxylate soap dispersion, was prepared in similar fashion to that described in U.S. Pat. No. 5,939,249 (noted above) and as described in Example 1.

A photothermographic emulsion formulation was prepared at 67° F. (19.4° C.) containing 174 parts of the above preformed silver halide, silver carboxylate soap dispersion and 4.6 parts of MEK. To this formulation was added 1.6 parts of a 15% solution of pyridinium hydrobromide perbromide in methanol, with stirring. After 45 minutes of mixing, 2.1 parts of an 11% zinc bromide solution in methanol was added. Stirring was continued and after 30 minutes, a solution of 0.18 parts 2-mercapto-5-methylbenzimidazole, 0.009 parts of Sensitizing Dye A, 2.0 parts of 2-(4-chlorobenzoyl)benzoic acid, 10.8 parts of methanol, and 3.4 parts of MEK were added. After stirring for 75 minutes, the temperature was lowered to 50° F. (10° C.), and 26.2 parts of PIOLOFORM® BM-18, 19.8 parts of PIOLOFORM® BL-16, and 50.9 parts of MEK were added. Mixing was continued for another 15 minutes.

The emulsion formulation was completed by adding the materials shown below. Five minutes were allowed between the additions of each component.

| Solution A containing: | | |
|---|---|---|
| Antifoggant AF-A | 0.80 | parts |
| Tetrachlorophthalic acid (TCPA) | 0.37 | parts |
| 4-Methylphthalic acid (4-MPA) | 0.71 | parts |
| MEK | 21 | parts |
| Methanol | 0.36 | parts |
| Solution B containing: | | |
| DESMODUR ® N3300 Solution | 0.66 | parts in |
| | 0.33 | parts MEK |
| Solution C containing: | | |
| Phthalazine (PHZ) | 1.32 | parts in |
| | 6.3 | parts MEK |

To 27.8 parts of the completed emulsion formulation was added the amount of reducing agent or reducing agent mixture shown in TABLE XVI.

TABLE XVI

| | | Amount |
|---|---|---|
| Sample | Reducing Agent(s) | (parts) |
| 7-1 Comparative | Compound III-1 | 0.87 |
| | Compound II-8 | 0.67 |
| 7-2-Inventive | Compound I-2 | 0.48 |
| | Compound III-1 | 0.27 |
| | Compound II-8 | 0.67 |
| 7-3-Comparative | Compound I-3 | 0.41 |
| 7-4-Inventive | Compound I-2 | 0.31 |
| | Compound III-4 | 0.21 |
| | Compound II-8 | 0.67 |

Overcoat Formulation-D:

Overcoat Formulation-D was prepared by mixing the following materials:

| | | |
|---|---|---|
| MEK | 292 | parts |
| PARALOID ® A-21 | 12.1 | parts |
| CAB 171-15S | 132 | parts |
| Vinyl Sulfone VS-1 | 0.96 | parts, 80.8% |
| | | active (0.78 parts net) |
| Benzotriazole (BZT) | 0.29 | parts |
| Acutance Dye AD-1 | 0.50 | parts |
| Antifoggant AF-B | 0.51 | parts |
| DESMODUR ® N3300 Solution | 1.54 | parts, in |
| | 0.76 | parts MEK |
| Tinting Dye TD-1 | 0.090 | parts |

Preparation of Photothermographic Materials:

The photothermographic emulsion and overcoat formulations were simultaneously coated onto a 7 mil (178 μm) polyethylene terephthalate support, tinted blue with support dye SD-1. An automated dual knife coater equipped with an in-line dryer was used. Immediately after coating, samples were dried in a forced air oven at 85° C. for about 5 minutes. The photothermographic emulsion formulation was coated to obtain a coating weight of between about 1.6 and 1.7 g of total silver/m². The overcoat formulation was coated to obtain a dry coating weight of about 0.2 g/ft² (2.2 g/m²) and an absorbance in the imaging layer between 0.90 and 1.00 at 815 nm.

The backside of the support had been coated with an antihalation and antistatic layer having an absorbance greater than 0.3 between 805 and 815 nm, and a resistivity of less than 10¹¹ ohms/square.

Samples of each photothermographic material were cut into strips, imaged with a laser sensitometer at 810 nm and developed as described in Example 1.

A strip sample of each photothermographic material was scanned using a computerized densitometer equipped with both a visible filter and a blue filter having peak transmission at about 440 nm. Image tone, measured at a visible density of 2.0, is the difference of the blue filter density from 2.0. Larger Image Tone values indicate a bluer image.

The data, shown below in TABLE XVII, demonstrates the advantage of reducing agent combinations comprising a trisphenol to provide improved Silver Efficiency, Image Tone, and hot-dark print stability.

TABLE XVII

| | | | Silver Efficiency | | | |
|---|---|---|---|---|---|---|
| | Initial | Initial | (Dmax/Ag Ct. | | Image Tone at | ΔOD-Blue at 1.2 After 3 Hours |
| Sample | Dmin | Dmax | Wt.) | Speed-2 | D = 2.0 | Hot-Dark Print Stability |
| 7-1-Comparative | 0.228 | 3.73 | 2.26 | 1.82 | 0.055 | 1.36 |
| 7-2-Inventive | 0.222 | 3.78 | 2.24 | 1.77 | 0.235 | 0.329 |
| 7-3-Comparative | 0.213 | 3.55 | 2.22 | 1.70 | 0.154 | 0.575 |
| 7-4-Inventive | 0.219 | 3.73 | 2.24 | 1.71 | 0.213 | 0.291 |

The invention has been described in detail with particular reference to certain preferred embodiments thereof, but it will be understood that variations and modifications can be effected within the spirit and scope of the invention.

1. A thermally developable material comprising a support having on at least one side thereof, one or more thermally developable imaging layers comprising in reactive association:
a. a non-photosensitive source of reducible silver ions,
b. a combination of reducing agents for said reducible silver ions, and
c. a polymeric binder,
wherein said combination of reducing agents consists essentially of at least one trisphenol represented by the following Structure (I), and
(a) at least one monophenol represented by the following Structure (II) or at least one bisphenol represented by the following Structure (III), or
(b) at least one monophenol represented by the following Structure (II) and at least one bisphenol represented by the following Structure (III): 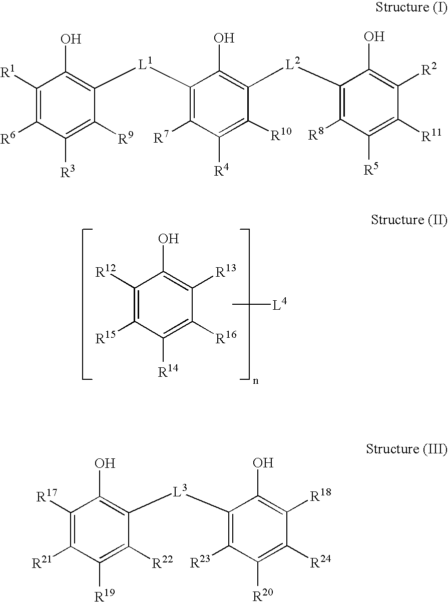
wherein L¹, L^{2,} and L³ are independently a methylene group or a mono-substituted methylene group.
R¹ and R² are independently substituted or unsubstituted primary or secondary alkyl groups having 1 to 8 carbon atoms.
R³, R⁴, R⁵, R¹⁹, and R²⁰ are independently substituted or unsubstituted alkyl groups having 1 to 6 carbon atoms.
R⁶, R⁷, R⁸, R⁹, R¹⁰, R¹¹, R¹⁵, R¹⁶, R²¹, R²², R²³, and R²⁴ are independently hydrogen, or substituted or unsubstituted methyl, ethyl, or methoxy groups, or chioro groups.
R¹², R¹³, R¹⁷, and R⁸ are independently substituted or unsubstituted primary, secondary, or tertiary alkyl groups haying 1 to 7 carbon atoms,
R⁴ is a substituted or unsubstituted alkyl group having 1 to 4 carbon atoms, and
n is 1 to 4. provided that when n is 2 or greater, L⁴ is a single bond or a linking group that is attached to any of R¹⁴, R¹⁵, or R¹⁶.

2. (canceled)

3. The thermally developable material of claim 1 wherein L^{1,} L^{2,} and L³ are unsubstituted methylene groups,
R¹ and R² are the same substituted or unsubstituted primary or secondary alkyl groups,
R^{3,} R^{4,} R^{5,} R^{9,} and R²⁰ are the same substituted or unsubstituted methyl or ethyl groups,
R⁶, R⁷,R⁸, R⁹, R¹⁰, R¹¹, R¹⁵, R¹⁶, R²¹, R²², R²³, and R²⁴ are independently hydrogen or unsubstituted methyl groups,
R¹², R¹³, R¹⁷, and R¹⁸ are independently substituted or unsubstituted secondary or tertiary alkyl groups having 3 to 7 carbon atoms, and
R¹⁴ is a substituted or unsubstituted alkyl group having 1 to 4 carbon atoms.

4. The thermally developable material of claim 3 wherein R¹⁴ is a CH₂CH₂(C=O)- group, n is 4, and L⁴ is a (-OCH₂)₄C- group.

5. The thermally developable material of claim 1 wherein the molar ratio of the reducing agent of Structure (I) to the total reducing agents of Structure (II) and (III), is from about 0.1:1 to about 50:1.

6. The thermally developable material of claim 1 that is a photothermographic material and further comprises a photosensitive silver halide.

7. The thermally developable material of claim 1 further comprising a high contrast enhancing agent, co-developer, or both.

8. The thermally developable material of claim 7 wherein said high contrast enhancing agent or co-developer is a substituted acrylonitrile compound, a trityl hydrazide or formyl phenyl hydrazide, hydroxylamine, alkanolamine, ammonium phthalamate, hydroxamic acid, N-acylhydrazine, or hydrogen atom donor compound.

9. The thermally developable material of claim 1 wherein the total amount of silver is less than 1.9 g/m².

10. The thermally developable material of claim 1 further comprising a protective overcoat layer disposed over said photothermographic layer.

11. The thermally developable material of claim 1 wherein the molar ratio of all reducing agents of Structure (I) through (III) to total silver is from about 0.05 mol/mol of total silver to about 0.5 mol/mol of total silver.

12. The thermally developable material of claim 1 wherein the reducing agent of Structure (I) is present in an amount of from about 0.5 to about 30 weight % and the total amount of reducing agents from Structure (I), (II), and (III) is from about 1 to about 45 weight %.

13. A photothermographic material comprising a support having on at least one side thereof, one or more thermally developable imaging layers comprising in reactive association:
a. a photosensitive silver halide,
b. a non-photosensitive source of reducible silver ions,
c. a combination of reducing agents for said reducible silver ions, and
d. a polymeric binder,
wherein said combination of reducing agents consists essentially of at least one trisphenol represented by the following Structure (I), and
(a) at least one monophenol represented by the following Structure (II) or at least one bisphenol represented by the following Structure (III), or
(b) at least one monophenol represented by the following Structure (II) and at least one bisphenol represented by the following Structure (III): 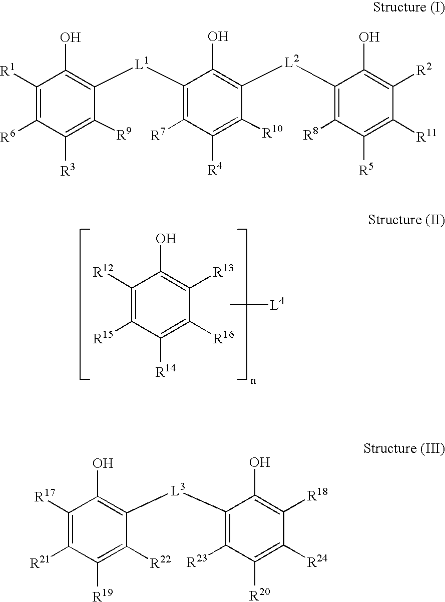
wherein L¹, L^{2,} and L³ are independently a methylene group or a mono-substituted methylene group.
R¹ and R² are independently substituted or unsubstituted primary or secondary alkyl groups having 1 to 8 carbon atoms.
R³, R⁴, R⁵, R¹⁹, and R²⁰ are independently substituted or unsubstituted alkyl groups having 1 to 6 carbon atoms.
R⁶, R⁷, R⁸, R⁹, R¹⁰, R¹¹, R¹⁵, R¹⁶, R²¹, R²², R²³, and R²⁴ are independently hydrogen, or substituted or unsubstituted methyl, ethyl, or methoxy groups, or chloro groups.
R¹², R¹³, R¹⁷ and R¹⁸ are independently substituted or unsubstituted primary, secondary, or tertiary alkyl groups haying 1 to 7 carbon atoms

14. A black-and-white, organic solvent based photothermographic material comprising a support and having on at least one side thereof a photothermographic layer and comprising, in reactive association:
a. a photosensitive silver halide,
b. a non-photosensitive source of reducible silver ions, comprising at least silver behenate,
c. a combination of reducing agents for said reducible silver ions, and
d. a polyvinyl butyral or polyvinyl acetal binder, and
wherein the total amount of silver is present in an amount of at least 1 g/m² and less than or equal to 2.5 g/m².
said combination of reducing agents consists essentially of combination of either or both of Compounds I-2 and I-3 with either or both of Compounds II-8 and ii-17,
a combination of either or both of Compounds I-2 and I-3 with either or both of Compounds III-1 and III-4, or
a combination of either or both of Compounds I-2 and I-3 with either or both of Compounds II-8 and II-17 and either or both of Compounds III-1 and III-4,
a co-developer compound that is optionally present in an amount of from about 0.0005 to about 0.15 g/m², and
a high contrast enhancing agent that is optionally present in an amount of from about 0.001 to about 0.5 g/m²,
the structural formulae of compounds I-2, I-3, II-8, II-17, III-1, and III-4 represented by:

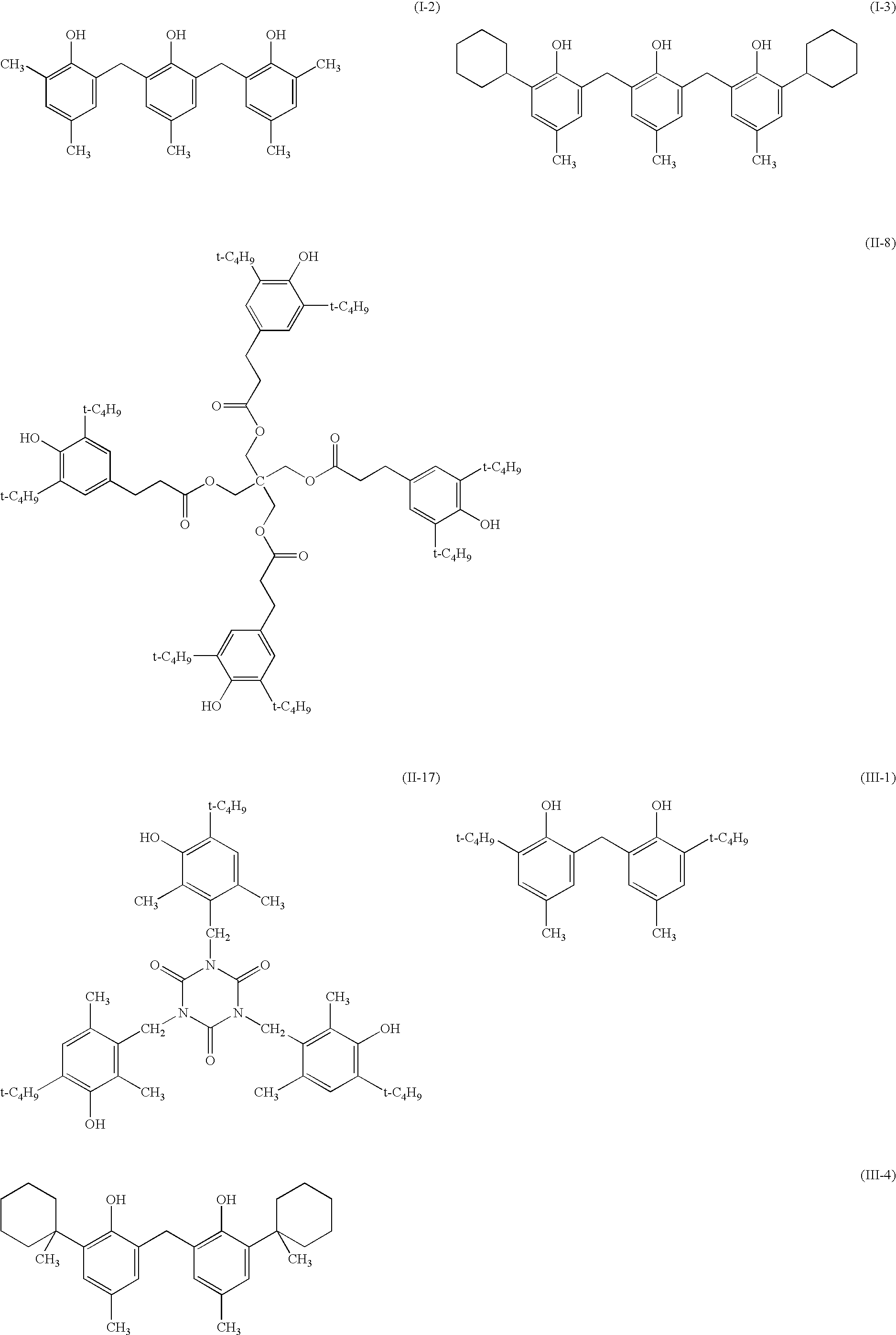

15. The photothermographic material of claim 14 wherein said co-developer is a substituted acrylonitrile.

16. The photothermographic material of claim 14 wherein said high contrast enhancing agent is a hydroxylamine, alkanolamine, ammonium phthalamate, hydroxamic acid, N-acylhydrazine, or hydrogen atom donor compound.

17. A method of forming a visible image comprising:
A) imagewise exposing the material of claim 1 that is a photothermographic material to electromagnetic radiation to form a latent image, and
B) simultaneously or sequentially, heating said exposed photothermo-graphic material to develop said latent image into a visible image.

18. The method of claim 17 wherein said development is carried out for 25 seconds or less.

19. The method of claim 17 wherein said imagewise exposing is carried out using laser imaging at from about 600 to about 1200 nm.

20. A method of forming a visible image comprising thermal imaging of the material of claim 1 that is a thermographic material.
